(19) United States
(12) Patent Application Publication
(10) Pub. No.: US 2005/0227216 A1
(43) Pub. Date: Oct. 13, 2005

(54) Method and system for providing access to electronic learning and social interaction within a single application

(76) Inventor: Puneet K. Gupta, Newark, CA (US)

Correspondence Address: CENTRAL COAST PATENT AGENCY, PO BOX 187, AROMAS, CA, 95004, US

(21) Appl. No.: 10/994,026

(22) Filed: Nov. 19, 2004

Related U.S. Application Data
(60) Provisional application No. 60/561,618, filed on Apr. 12, 2004.

(51) Int. Cl. G09B 7/00

(52) U.S. Cl. 434/322

(57) ABSTRACT

A system for managing academic and social life for students includes a central server connected to a wide-area network and storing a repertoire of logic functions for use by students in managing academic activities; and a plurality of computerized appliances associated with individual students, the computerized appliances connectable to the wide-area network. The students may download logic from the central server, and execute the logic to configure and manage activities related to classes and studies in a college or university, and may interact with other students through the central server. In one aspect the system further includes one or more distributed servers connected to the wide-area-network the servers adapted for network-based academic learning and for communication with the central server over the network; and one or more content servers connected to the wide-area-network, the content servers adapted to provide Web-based content and services to students through the central server.

### CROSS-REFERENCE TO RELATED DOCUMENTS

The present invention claims priority to a U.S. provisional patent application No. 60/561,618 entitled “A Comprehensive Data, Productivity and Time Management Application with Interactive Interface for Students” filed on Apr. 12, 2004 disclosure of which may be referred to herein by reference.

### FIELD OF THE INVENTION

The present invention is in the broad field of work and data management, and pertains more particularly to a comprehensive data, productivity and time management application with an interactive interface for students that provides interactivity related to electronic learning systems and social interactive systems.

### BACKGROUND OF THE INVENTION

Internet portal systems are well known in the art, and provide functionality for users of Internet-connectable computer appliances, such as personal computers, laptop computers and personal digital assistants, to leverage data and applications on the Internet network. In the continuing development of such systems, client side functionality is being added and integrated in some systems, allowing users to interact with data and executable logic on both the Internet and more local systems at the user's premise. Some of these applications are coming to be known in the art as Smart Clients. An example of a system for creating Smart Clients is the Microsoft™ Smart Client framework known as the .NET framework, known to the skilled artisan.

Up until the time of filing of the instant application, available applications such as browsers with plugins and specialty portal systems have provided substantial scalability and manageability to computer appliance users, but at a price of poor support for rich interactivity.

In addition to the above there is now a well-documented trend for bodies of students, such as college and university attendees, to acquire and use computerized appliances such as laptop computers in organizing their schedules, planning tasking and workflow, and in preparing and submitting homework and other assignments, for example. The inventors estimate that in the next few years, use of a laptop computer will become substantially mandatory for college and university students.

In addition to the above the inventors are also aware that no single, comprehensive application exists today for use with a laptop computer or other computerized appliance to allow a student to interact, learn, manage data and workflow, and to generally manage day-to-day learning-related activities both on and off campus. The environment of college and university students is rapidly becoming more comprehensively digital and tools to help a student cope are sorely needed.

Another factor in the overall equation of a more digital environment for students and the ability of students to handle the new developments is the fact that the level of digital expertise of students is rising with every new group of freshmen. Those entering colleges and universities in the autumn quarter or semester of 2004 will be the first generation to have grown up with the Internet network. This group will be the most digital and computer savvy group to have ever entered college or university. This group will be intimately familiar with Internet medium and all of its related procedures and skills, such as web browsing, Internet messaging, smart phones, PDAs, MP3 players, computers and laptops of all kinds, and more.

As the environment becomes more digital, certain problems are exacerbated, to become productivity obstacles. Consider:
Colleges and Universities, undergoing shrinking capital budgets, are ill prepared to cater to student's needs and requirements, particularly in the areas of Information Technology (IT) tools and technologies.
The students are used to state-of-the-art gadgets and IT infrastructure, and are expecting the same on campus. However, the colleges and universities may be technically behind other institutions in provision of state-of-art Internet technology (IT) infrastructure.
At least partly because the cost of tuition continues to rise, there is a trend for students to carry a heavy workload with an increasing number of class hours each quarter or semester, to be more cost effective. This creates a more stressful atmosphere.
While on the surface it may seem that owning and using a laptop is at least a partial solution to the problems of a more digital environment, in the absence of a productivity management application specifically designed for the student body and education domain, the hardware is a poor solution.

The inventor is aware of several campus or university-based electronic learning systems that use the well-known server/client, Internet-based communication method over a data network to enable students to engage in online learning according to availability of class material, testing materials, and so on. These systems are widely known in the art and are marketed by some third parties as IT solutions for universities and campuses under trade names such as Black Board™ learning management system. These types of systems employ a central server (typically LAN/WAN connected) that is adapted to serve, upon login-access, materials and interactive tools and applications adapted to facilitate online learning through electronic or e-courses and for taking online quizzes and tests associated with the same.

Some drawbacks to these types of systems are as follows;
They are dedicated solely to education interaction.
They may require scheduled online participation in order to complete tasks.
They are proprietary in nature and not integrated from system to system or to latest IP conventions.
Client-side Web-based applications are dedicated only for interaction with the education server.
Are subject to participation or non-participation by university professors rendering overall online availability to students of classes for any major or minor field incomplete.

With these additional problems in the art, students who are computer and application knowledgeable become less able to efficiently manage workload, social interaction, time management, and other tasks using the resources that are currently available through computer software applications and university or campus-based systems.

Therefore what is needed is a comprehensive data, productivity, and time management application interface for students having functionality for facilitating students in the management of their academic lives and social lives, including like components adapted for professors, lecturers, et al. to achieve like management capabilities while still leveraging in-place electronic learning systems.

### SUMMARY OF THE INVENTION

A system is provided for managing academic and social life for students and includes a central server connected to a wide-area network and storing a repertoire of logic functions for use by students in managing academic activities, and a plurality of computerized appliances associated with individual students, the computerized appliances connectable to the wide-area network. In one embodiment, students may download logic from the central server, and execute the logic to configure and manage activities related to classes and studies in a college or university, and may interact with other students through the central server.

In a preferred embodiment, the wide-area network is the Internet network. In one embodiment, the computerized appliances associated with individual students connect to the wide-area network through a wireless system. Also in one embodiment, the central server includes a suite of logic functions for teachers to interact with the central server and student users.

In a preferred embodiment the system enables integrating and managing academic and social activities from a single point of control and further includes, in one embodiment, one or more distributed servers connected to the wide-area-network, the servers adapted for network-based academic learning and for communication with the central server over the network; one or more content servers connected to the wide-area-network, the content servers adapted to provide Web-based content and services and adapted for communication with the central server; and one or more instances of software distributed to network-capable computing devices, the software instances adapted for managing aspects of academic and social activities in conjunction with the main server for the operators of the computing devices.

In one embodiment, the central server includes an application server for serving downloadable content and software modules and at least one server adaptor for translating data format between the central server and distributed servers. In one embodiment, the content servers are advertisement servers. In this embodiment, Web-based content provided by the content servers includes geographically sensitive advertisement content localized to a specific region of an end user of the content. Also in this embodiment, the advertisement content includes job resources, financial resources, and entertainment resources. In another embodiment, the content servers are portal servers providing access to Web-based services to end users of the content.

In one embodiment, the instances of software are student interfaces and the operators are students. In another embodiment, the instances of software are faculty interfaces and the operators are members of a faculty. In a preferred embodiment, the instances of software are a mix of student and faculty interfaces and the operators are a mix of students and faculty.

In one embodiment, the at least one server adaptor includes software for interfacing, for data migration, for data abstraction, and for XML data generation. In this embodiment, the central server further includes software for generating application templates, for building applications, and for integrating third-party content into end-user display data.

In a preferred embodiment, the network-capable computing devices are one or a combination of laptop computers, desktop computers, cellular telephones, and personal digital assistants. Also in a preferred embodiment, the central server further includes data storage volumes personalized and allocated for use by the server and by the operators of the computing devices.

According to another aspect of the present invention, a graphics user interface is provided for controlling and for managing aspects of academic and social interaction of the interface operator. The interface includes a registration and configuration component for enabling registration and configuration of the interface to receive data from and to enable interaction with a central server; a networking component for enabling navigation on a data network; a messaging component for receiving and sending message content over the network; a processing component for enabling document generation, data manipulation, and mathematical calculations based on rule; and a file sharing component for enabling data sharing between interface operators according to file permissions and rules.

In a preferred embodiment, the interface is operable in online mode in collusion with a server-based software application and in offline mode for accomplishing academic workflow. In one embodiment, the interface is adapted for a student registered with a network-based learning management system. In another embodiment, the interface is adapted for a faculty member registered with a network-based learning management system.

In a preferred embodiment, data received includes registered course materials and assignments including manipulability thereof in offline mode. In one embodiment, the central server functions as a proxy to one or more learning management systems the interface operator is registered with. In a preferred embodiment, the data network is the Internet network including connected sub-networks.

In one embodiment, the networking component is a resident browser application incorporated for use by the interface. Alternatively, the networking component is a browser application generic to the interface. In one embodiment, the messaging component is a resident instant message application incorporated for use by the interface. Alternatively, the messaging component is an instant message application generic to the interface.

In one embodiment, the messaging component is a resident email application incorporated for use by the interface. In another embodiment, the messaging component is an email application generic to the interface. In still another embodiment, the messaging component integrates both instant message and email applications.

In a preferred embodiment, the processing component uses mathematical calculation to forecast one or more financial scenarios. In one embodiment, the processing component uses mathematical calculation to predict course grades required to attain a desired grade point average related to a number of courses. In one aspect of this embodiment, calculation is based on a rule that distributes grade level rise evenly over the number of courses.

In a preferred embodiment, the processing component includes a utility for taking class notes. In a preferred aspect of this embodiment, the utility further includes automatic file naming and archiving capabilities related to course description. In one embodiment, the file-sharing component is integrated with the messaging component. In this embodiment, the file-sharing component includes sharing of calendar data according to file permissions.

In a preferred embodiment, sharing of calendar data is integrated with the processing component to process shared calendar data for common calendar dates open for scheduling using multiple shared calendars or portions thereof covering same periods of time. In one embodiment, the processing utility processes calendar data for common calendar dates occupied by the least number of scheduled engagements. In a preferred embodiment, the messaging component is an instant message application that reports presence information related to contacts online status and calendar information.

According to another aspect of the present invention an instant messaging application is provided. The application includes an indexing utility for categorizing and organizing contacts; a presence reporting utility for detecting online activity of listed contacts; and a presence reporting utility for detecting scheduled activities documented and set for sharing by contacts and reporting those activities as presence information. In one embodiment, the scheduled activities are resultant of integration of the application to a shared calendar utility. In one preferred embodiment, a mouse click executed on a listed contact expands the contact to reveal current online status and text description of scheduled activities including times and locations of those activities listed.

### BRIEF DESCRIPTION OF THE DRAWING FIGURES

FIG. 1 is an architectural overview of a communications network wherein electronic learning, time management, and social interaction capabilities are integrated according to an embodiment of the present invention.

FIG. 2 is a block diagram illustrating basic software components of the server of FIG. 1 according to an embodiment of the present invention.

FIG. 3 is a screen shot of a set-up interface of a client application for students according to an embodiment of the present invention.

FIG. 4 is a screen shot of a message inbox of a client application for students according to an embodiment of the present invention.

FIG. 5 is a screen shot of an integrated home page of a client application for students according to an embodiment of the present invention.

FIG. 6 is a process flow chart illustrating steps for merging student calendars according to an embodiment of the present invention.

FIG. 7 is a process flow chart illustrating steps for predicting financial scenarios according to an embodiment of the present invention.

FIG. 8 is a screen shot of an integrated home page illustrating a shared calendar view according to an embodiment of the present invention.

FIG. 9 is a block diagram illustrating connection architecture for party interaction with the server of FIG. 1 according to an embodiment of the present invention.

FIG. 10 is a screen shot of an integrated home page illustrating a merged calendar view and an IM interface according to an embodiment of the present invention.

FIG. 11 is a screen shot of an IM interface illustrating presence location information according to an embodiment of the present invention.

FIG. 12 is a screen shot of an integrated home page illustrating an embedded IM and third-party advertisements according to an embodiment of the present invention.

FIG. 13 is a screen shot of a promotions page populated with third-party offers according to an embodiment of the present invention.

FIG. 14 is a screen shot of a student interface for adding class information according to an embodiment of the present invention.

FIG. 15 is the screen shot of FIG. 14 illustrating further data entry fields for adding class details according to an embodiment of the present invention.

FIG. 16 is the screen shot of FIG. 14 illustrating further data entry fields for adding instructor details according to an embodiment of the present invention.

FIG. 17 is the screen shot of FIG. 14 illustrating further data entry fields for adding office and session details according to an embodiment of the present invention.

FIG. 18 is a screen shot of an office schedule input interface for adding office schedule details according to an embodiment of the present invention.

FIG. 19 is a screen shot of a grade point average forecasting interface for running GPA scenarios according to an embodiment of the present invention.

FIG. 20 is a screen shot of a client application for a faculty member illustrating a class roster according to an embodiment of the present invention.

FIG. 21 is a screen shot of a client application for a student illustrating download of a new configured class according to an embodiment of the present invention.

### DESCRIPTION OF THE PREFERRED EMBODIMENTS

According to an embodiment of the present invention, the inventor provides a system for interaction over a network between students and faculty of a learning or education system including participation by third party entities and social participants. In one embodiment both students and faculty are enabled with client applications that communicate with a central server application. In other embodiments where faculty may not be so-enabled, students leverage existing systems and manually entered offline data use their client applications to fully integrate their online and offline academic lives.

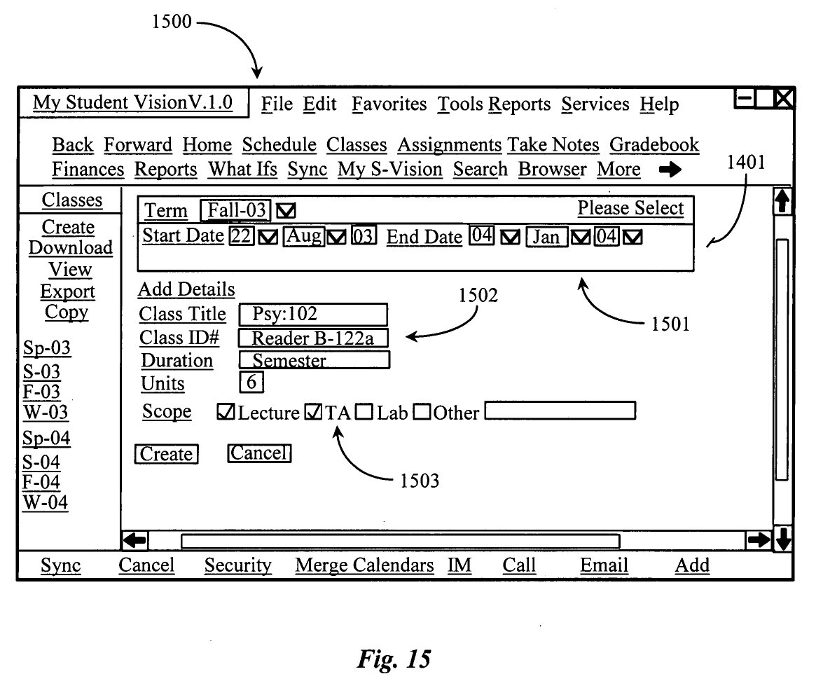

Referring now to U.S. provisional patent application No. 60/561,618, FIG. 15, in one embodiment both students and faculty members interact using client applications and a central network-based server application known to the inventor as an Edu-connect server. In this embodiment, individual client applications including those for faculty and for students enable interaction through the server and are adapted for enabling planning and organization of the academic lives of both students and faculty essentially replacing and enhancing capabilities formerly available through prior-art educational systems.

However, in one embodiment it is realized that in some educational environments existing systems will remain in place and many faculty members of a universities staff may still operate both in an online mode (with some courses) and in an offline mode (with some courses) using traditional educational management software (online courses) and on-site classroom lecture and testing methods (offline courses). Still further, some education providers may remain entirely offline with respect to university or other educational system-offered courses requiring students to physically attend lectures and testing.

Therefore, in one embodiment of the present invention, a unique server-based data and language adaptor is provided as well as a manual course data-entry client interface that enables a student with a client application to be more flexible in the management of aspects of his or her offline academic life as well as his or her current Learning Management System (LMS)-constrained academic life in ways that both enhance and provide new functionality. The methods and apparatus of the present invention are provided in enabling detail below.

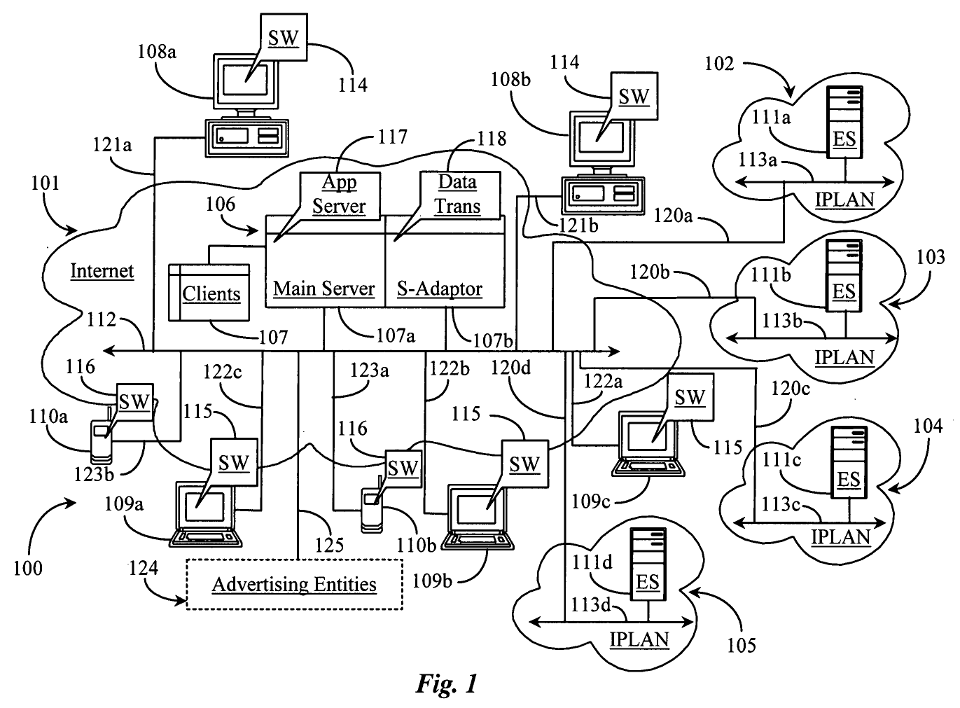

FIG. 1 is an architectural overview of a communications network 100 wherein electronic learning, time management, and social interaction capabilities are integrated according to an embodiment of the present invention. Communications network 100 includes a wide-area-network (WAN) 101, referred to hereinafter as Internet 101 according to a preferred example, and a plurality of connected sub networks identified herein as Internet protocol local area networks (IPLAN) 102, IPLAN 103, IPLAN 104, and IPLAN 105. IPLANs 102-105 represent largely proprietary university or other educational LMS networks all having connection to a larger data network or WAN, in this case, Internet 101.

For example, an Internet backbone 112 is illustrated within Internet network 101. Backbone 101 represents all of the network lines, connection-access points, and equipment that make up the Internet network analogous in this example to the well-traversed World Wide Web (WWW) as a whole. IPLAN 102 has connection to backbone 112 from a LAN backbone 113a via an Internet access line 120a. IPLANs 103-105 are similarly connected in this example. For IPLAN 103 the connection is defined as backbone 113b to backbone 112 over Internet access line 120b. For IPLAN 104, connection to the larger network is illustrated as backbone 113c over Internet access line 120c to backbone 112. For IPLAN 105, connection to the larger network is illustrated as backbone 113d over Internet access line 120d to backbone 112.

IPLANs 102-105 represent largely proprietary network-based learning systems such as, for example, the Black Board™ learning system known to the inventor. Therefore, the levels of cooperation between systems 102-105 may be varied or, in some cases non-existent. Each separate IPLAN 102-105 includes a centralized education server (ES) 111a (network 102); ES 111b (network 103); ES 111c (network 104); and ES 111c (network 105). The exemplary configuration may represent 4 separate educational systems for 4 separate university or educational systems. As such, these systems may be largely remote from one another in geographic terms, but reachable through Internet network 101. Internet access lines 120a-120d may be 24/7-connected or may be connected through separate Internet Service Providers (ISPs) not illustrated in this example. There are many architectural possibilities including integration of wireless services.

As described further above, students may be adapted through software and Internet-capable devices for interacting with one or more ES servers for facilitating interactive learning according to offered content made available. In typical art, students taking online courses may be constrained to interacting with one ES server due to limited client application capability in a largely proprietary way. For example, students taking online classes through ES 111d accessing IPLAN 105 using a client software application may be required to download a totally separate application if they also wish to enroll and take online classes offered through ES 111a. Still further limitations for each client application may require that a student operator be connected for the duration of any online activity sanctioned through servers 111a-111d. This may apply to all course activities.

In a preferred embodiment of the present invention, a Web-based educational server 106 is provided within the domain of network 101 and is accessible there through to clients operating a variety of network-capable computing devices. In one embodiment of the present invention, server 106 is analogous to server 1501 described with reference to FIG. 15 of co-pending patent application 60/561,618, termed an Edu-Connect™ server by the inventor. In a preferred embodiment server 106 functions as a central hub enabling users through client applications to interact with more that one learning system, wherein those systems may represent disparate universities or educational systems, which may, in addition be geographically remote from one another. Likewise, server 106 bridges traditional limitations of proprietary interfacing, which will be detailed further below.

In one embodiment of the present invention, server 106 includes a main server portion 107a and a server adaptor portion 107b. In this embodiment server 106 has at least two main port functions illustrated logically herein by a dual connection to Internet backbone 112. These are direct communication capability with client-operated computing devices over the network and direct communication capability with ES (servers) 111a-111d. In one embodiment, there is provided at least one other port for enabling direct proxy connections between clients and ES servers.

Main server 107a has an application server 117 adapted to serve customized content to server clients. S-Adaptor portion 107b includes a server application 118 adapted to receive data from servers 111a-111d, and to translate that data into a form useable by main server application 117. This is accomplished through data abstraction and data modeling techniques that will be further discussed later in this specification.

Clients of server 106 may include desktop clients 108a and 108b running a version of client application (SW) 114 adapted for desktop computers. Clients of server 106 may also include laptop clients 109a, 109b, and 109c running a version of client application (SW) 115 adapted for laptop computers. Clients of server 106 may further include cell-phone clients 110a and 110b running a version of client application (SW) 116 adapted for cellular telephones. Clients 108a, 108b, 109a, 109b, 109c, 110a, and 110b, may be student clients or faculty clients, or a mix thereof. Therefore, SW versions of client applications 114, 115, and 116 may be varied in configuration for device type and for client type accordingly.

If for example, desktop clients 108a and 108b are teachers, then client applications 114 are configured for faculty use, termed Faculty Vision™ by the inventor. If then laptop clients are students then client applications 115 are configured for student use, termed Student Vision™ by the inventor. Likewise, each SW application 114-116 may share many of the same functional components even though there are device-type and client-type differences incorporated therein. For example, SW 114 and 115 may be system and platform similar for use on robust computing stations while SW 116 is a light-weight version adapted for smaller and less-robust devices like cellular telephones or personal digital assistants (PDAs).

Each client application 114-116 is, in a preferred embodiment, adapted to provide an interactive user interface that enables the client to communicate with server 106, and through server 106 to one another, and in some embodiments, through server 106 to ES servers 102-105. In the latter 2 cases server 106 functions also as a proxy server.

Client devices 108a- 110b may have various and sundry means for establishing connection to Internet 101 and ultimately to server 106. Desktop clients 108a and 108b have connection to backbone 112 via Internet access lines 121a, and 121b respectively. One with skill in the art will recognize that varied connection types and services may apply such as dial-up Internet access through an ISP for example. Broadband cable, Digital Subscriber Line (DSL), Integrated Services Digital Network (ISDN) may also apply. In some cases, connection at the end local to the client is accomplished via a wireless access service. The same parameters may be assumed possible regarding laptop clients 109a-109c, however these clients are more likely to connect via an available wireless service such as WiFi™ using an 802.xx wireless protocol. Cellular telephones 110a and 110b may be connected through an existing Internet inclusive wireless telephone plan. There are many possibilities.

In a preferred example, clients may have more than one computing device configured with client SW for access to server 106 and can, from a mobile standpoint, access limited services from any Internet capable device even if no client application exists on the machine used to gain access. In a preferred embodiment, however, each client has at least one client application downloaded and installed on a primary computing device that will be used most often to access services from server 106.

Server 106 has a client database application provided therein and illustrated physically as a mass repository 107 connected to main server 106. Repository 107 may be external as illustrated or it may be held internally without departing from the spirit and scope of the present invention. Client repository 107 is adapted to hold and maintain data attributed to clients that are registered to use the system of the present invention. Data about clients, in a preferred example, is populated in individual client memory spaces allotted to each client. Such memory space shall be sufficient for each client according to the needs of each client. Such space includes space for holding course descriptions and course materials, space for holding messages, space for holding schedule-based information, space for holding contact information, and space for holding system generated information. The exact amount of space allotted to each registered client may depend upon many variables such as type of client, activities of client, and so on.

Each client registered with server 106 and owning a client SW application has a unique server-assigned identification number or code that also applies to the client's individual server space. By allocating individual server space and storing course materials and client-generated as well as server-generated documents, a client may synchronize with server 106 in order to download and upload materials as may be required during practice of the present invention enabling the client to perform much academic work in an offline mode.

Client applications 114-116 aided by server application 117 enable a previously unavailable level of integration of the academic life of a student and the online social and business life of a student. Advertising entities 124 have connection to server 106 through access line 125. Advertising entities represent virtually any third-party provider that has an online presence and capability through such as advertisement servers to send advertisements to network servers like server 106. Advertisement entities 124 may also include third-party services that may add functionality to a client's application interface that may not be available entirely from server 106. For example, links may be provided to search utilities and other online resources designed to aid students in their academic endeavors. Financial services, portal services, research tools and databases may all be made available for integration into a student's online interface.

In practice of the present invention according to one embodiment, a student may register to receive online courses from a university or other educational provider using one or more ES servers 111a-111d. In this respect, the individual servers will provide client applications or browser plug-ins that will enable a student, without the aid of the present invention, to go online and communicate with that server or servers when required for the express purpose of engaging in and completing the educational tasks and related assignments rendered accessible to a student through that server or servers. With the aid of the present invention, once a student is registered to one or more of those servers he or she may download a client application from main server 107a and enter the parameters of the server-based course registration including ID, authentication information, server address, and the like. The student may then upload this information to server 107a.

The uploaded information may now be applied as part of the student's individual space registered at server 106 under the student's unique server-assigned ID number. The registered information will appear in the client application for the student in aggregate meaning the information from all of the identified systems.

Adaptor 107b may, through the provided server-to-server connections, access the identified ES servers and may retrieve the course descriptions, documents, schedules, calendar information, task modules, and any other pertinent data that otherwise a student would utilize while online with that server and transform the data and identified functionalities into data and functionalities that are compatible with application server 117 and client SW instances 114-116.

In the above-described case, it may be that the faculty responsible for originating and conducting the online course materials available at one or more of servers 111a-111d does not have, nor intends to acquire client-access to server 106 or a client application there from. However, through permissions granted at the server level, any of the ES servers 111a-111d may be configured as illustrated in this example, to establish communication with and to transfer data to server 106 through adaptor portion 107b. Application 118 renders such transferred data in asynchronous or, in some functional instances, synchronous mode, in an abstracted extensible markup language (XML)-based format using a simple object application protocol SOAP transport protocol. The abstract XML description may then be used as input for constructing templates, documents, and other useable and interactive client-side modules. Such materials may then be stored on behalf of and served to a client working with one of SW instances 114-116.

In similar fashion to the above, materials that have been abstracted and formatted for use by client SW instances 114-116 wherein working with such materials by a client has generated further data such as finished assignment materials, populated test forms, documents, and other related data, may be uploaded to the appropriate ES servers in a form reverted back to the original content format useable by those servers. In this way, a client may engage in courses or classes available through geographically disparate and application language disparate online educational servers and dispose of the tasks, and assignments retrieved there from according to assigned requirements using only a single education SW interface.

By virtue of using one of SW interfaces 114-116 a client may also partake in other non-academic and academic related activities using the same interface and may engage in online interaction with other clients registered with services provided through server 106. For example, email and other messaging may be hosted by server 106 including hosting of connections to third-party services and advertisements all of which may be integrated into and viewable from the same SW interface.

In one embodiment of the present invention, faculty members charged with the responsibility of providing course materials and conducting activities through servers 111a-111d may also acquire a client application 114-116 and may use that interface to create, maintain, and monitor course materials and activities made available through servers 111a-111d all through a single SW interface. Faculty members so enhanced may engage in interaction with a larger community of both faculty members and students that are registered with services provided through server 106.

The flexibility of being able to interact with and manage course materials hosted by otherwise disparate servers 111a-111d through a single interface provides motivation to register with server 106.

With the aid of the system of the present invention, new educational communities may be formed that cross traditional educational, physical, and cultural boundaries created by isolated online learning systems. For example, a student may use a single interface to register for and receive credit for classes offered by geographically remote universities by leveraging their “in place” online learning systems. Likewise, a professor may teach at geographically remote universities and may grade and monitor students through a single online interface. In addition, those classes conducted in offline mode such as by traditional classroom attendance and offline homework assignments may, to some extent, be integrated into the system of the present invention by students at least for scheduling and assignment alert functionality and for class research and document generation purposes such as doing homework or taking notes related to the offline course materials.

In addition to providing tools for consolidating online courses and offline course information within a single workflow oriented platform, many other enhancements related to other aspects of academic life are possible. For example, collaboration by several students working on one course-related project is made possible using the SW interface in communication mode wherein online meetings or chats can be conducted on an impromptu basis. Likewise, group-oriented browser sessions may be conducted as well as group messaging.

In a preferred embodiment at least one optimized information sharing capability, termed a Smart Calendar™ by the inventor, is provided wherein several individuals may share calendar information in order to calculate dates (via algorithmic function) where they all may get together for a face-to-face meeting or for an online meeting. In one embodiment a unique instant messaging interface is provided for the purpose of keeping track of the online activities and schedule information of student friends, faculty members, and associates.

In an educational environment, especially in a university environment, students have classmates, associates from extracurricular activities, sorority mates, and general acquaintances. Therefore, presence information of friends and associates (online, and by schedule) can be leveraged to optimize scheduling and to locate individuals. For example, if a student has a roommate that attends the same university and has the SW of the present invention, the roommate can share his or her schedule and access to online presence information through an instant messaging utility adapted as part of SW 114-116. One click on the roommates name provides online status (online/offline) and current online location. In one embodiment, online history and future (scheduled) online activities may also be provided through a mix of actual navigation history of the roommate and activity that has not transpired but is scheduled to occur. Additional offline presence information can be viewed according to shared calendar information of the roommate.

In still another embodiment of the present invention, financial planning, curriculum planning and grade point average (GPA) estimation modules are provided and integrated within SW 114-116. In this embodiment, a student may plan and maintain his or her entire school curriculum or any portion thereof according to a desired degree including major and minor application. A student may also conduct financially related activities like online banking, investing, loan application research, and so on. In one embodiment, a student may run algorithmically enhanced scenarios to determine what financial conditions are required to meet projected financial obligations related to tuition and the like.

In a preferred embodiment SW 114-116 further includes a GPA calculator and forecaster that uses algorithmic functions to help a student determine what grades will be needed for individual classes to obtain an overall GPA desired or set as a goal. Using this tool, a student may run several scenarios that consider “minimal achievement factors” linked to certain classes carrying existing grades known to the equation. Run results may include system-generated suggestions related to workflow and class activity.

It will be apparent to one with skill in the art that the methods and apparatus of the present invention may be leveraged in a maximum or minimal organizational sense without departing from the spirit and scope of the present invention and that some features available may or may not be utilized by any given client. The system of the present invention leverages data of in-place educational systems and servers in order to save work and time by not requiring replacement or re-design of existing online course materials. However this should not be construed as a limitation of the present invention as such materials may be created new and may be used in accordance with the software and servers of the present invention. Moreover, such newly created materials may also be introduced as new options to be hosted in existing educational systems and servers without departing from the spirit and scope of the present invention.

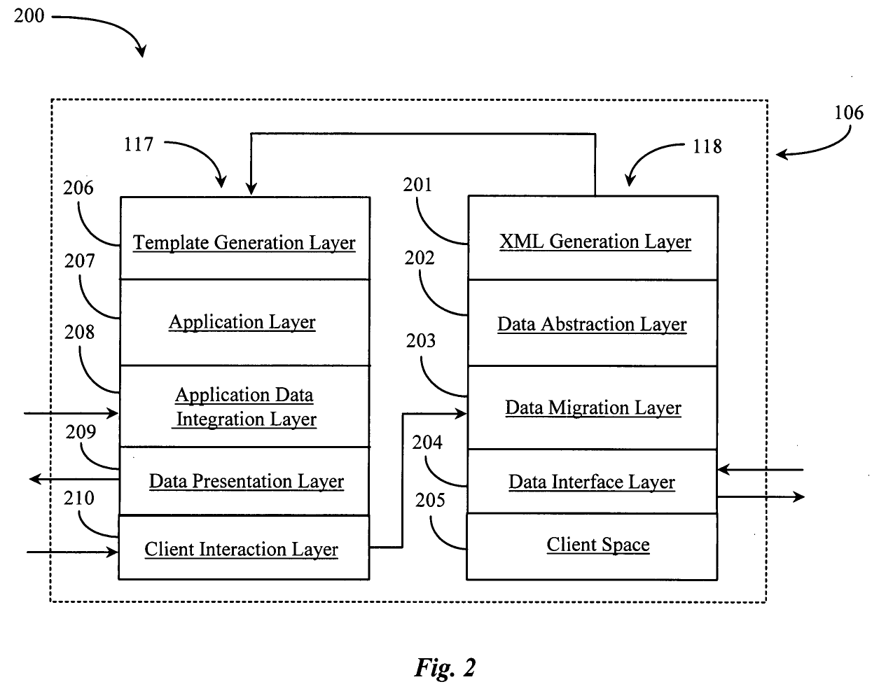

FIG. 2 is a block diagram 200 illustrating basic software components of server 106 according to an embodiment of the present invention. Server 106 is adapted for communication with educational system servers and with client devices as was described further above with reference to FIG. 1. Application 118 includes components for receiving data from educational systems and for transforming the data received so that it is useful to other server functions that require the information before functional applications can be built that will serve as forms, templates and functional modules useable in client interfaces communicating with the main server.

Application 118, in this embodiment, has a data interface layer 204 provided and adapted to enable server communication with external educational system servers analogous to servers 111a-111d of FIG. 1. Data interface layer 204 contains all of the components and software required to enable bi-directional communication with external servers using transfer control protocol/Internet protocol (TCP/IP) and other Internet protocols. Directional arrows representing data in and data out illustrate bi-directional server-to-server communication capability of sever 106. Data interface layer may also be ported for client/server interaction by proxy as will be further described below.

Application 118 has a data migration layer 203 provided thereto and adapted for processing data received from external servers according to an object-oriented framework that aggregates data for abstraction according to one or more functional data models representing formats and hierarchical presentation orders. Data blocks representing site and functional architecture of existing systems and data blocks representing information data or contained and formatted data are modeled according to highest level data models with attributes using a data modeling technique provided by a data abstraction layer 202.

Data migration and abstraction processes are well known in the art and may leverage, in some cases, middleware applications that are used to create object representations of the data wherein such objects can be manipulated in a more generalized way considering multiple disparate data sources. An XML generation layer 201 is provided to application 118 and is adapted to create the abstract XML description and instruction documents for use by other system components for data presentation, data manipulation, and data population.

In a preferred embodiment, application 118 is mostly automated except where some tasks may be performed by software engineers that may be required to write new data conversion modules, particularly if an existing learning system is particularly old or analogous to a legacy system. Therefore, a process of adapting an ES server to server 106 may include some manual tasks performed by software programmers, but ultimately may then may be largely or wholly automated for normal communication between the disparate systems. Once an ES system is adapted in terms of basic functionality and formatting meaning data forms, object containers, and architecture, then data used to populate the containers or forms can be translated and formatted on the fly between systems. The process may be adapted in many cases to work in both directions using well-known data mapping techniques. That is to say that data in one format stored on one server may be easily mapped into a different format for storage and retrieval on the other server.

Application 117 has a template generation layer 206 that is adapted to generate standardized templates for creating functional applications that can be used in place of disparate applications existing with the older in-place learning systems. An application layer 207 is provided within application 117 and is adapted, in a preferred embodiment, to enable functional applications that may manipulate data, receive data as input, and generate data as output.

An application data integration layer 208 is provided within application 117 and is adapted to accept data input from third party systems for integration into current data models available for servicing clients. Bi-directional arrows next to layer 208 logically represent ported network communication between server 106 and third party content and service providers. For example, a third party provider may send application data that may be packaged and co-branded as a Web service interface for integration with an existing data presentation model that may also be populated with education-related data, client data, and other data types. Such application functionality for allowing alternate presentation faces and for enabling plug-in integration capabilities can take on new and different forms than would otherwise be available through a standard education system server.

A data presentation layer 209 is provided and adapted to present data to client interfaces for interface display and for client interaction and for receiving data from a client through the interface. Data may be presented in a variety of ways and a client through option-based configuration tools available within his or her SW interface may order specific formats preferable to the client for display and preferable for client manipulation within the client interface. Bi-directional arrows next to layer 209 logically represent bi-directional ported communication capability between clients and server 106 using the data presentation layer in communication.

A client interaction layer 210 is optionally provided within application 117 and is adapted to enable any client to communicate with an ES system by proxy using his or her integrated SW interface (Student Vision™) instead of resident proprietary software that may have been provided by an ES server previous to the client registering with the system of the present invention. Using server 106 as a proxy server, a client may interact directly with an ES server using the original software interface as well. In this way, a client may still perform some tasks according to ES server protocols and rules while others can be managed from the new interface (SW 114-116).

Client interaction layer 210 may be adapted to enable communication according to more than one proxy scenario as described above. For example, in one embodiment a client may interact live with any of ES servers 111a-111d through server 106 using client interface SW 114-116 wherein data from an ES server is presented to the client through data presentation layer 209 according to the client's enhanced interface requirements and wherein data from the client is received through data presentation layer 209 and forwarded to the ES server through data migration layer 203, and data interface layer 204. In this scenario, data is mapped in real time back into the original ES formats accepted at the ES server. Therefore, a client may take an online test wherein the test questions are presented in an enhanced form that is different than the original form used at the ES server. The clients generated answers input into the Web form are then mapped back into the original Web form and in the format useable at the ES server.

In another scenario, a pure proxy connection may be established wherein no data transformation or migration is practiced. In this scenario, a client may utilize his or her existing ES server interface to interact with ES server functionality, forms, and formats through client interface layer 210 and data interface layer 204. In this case data does not have to be presented in a format useable with SW 114-116 because it is not being used for the particular connection. Server 106 simply hosts the through connection. In this way, some prior functionality available with original ES software may be preserved if so desired by a client.

An example of the above scenario might be that of a live classroom lecture being conducted through ES server 111a for students, for example, and the nature of the interaction is better supported (in a client's view) using the original ES user interface (UI) for graphics sharing and voice capture. However, SW 114-116 may still be used during the session in an integrated fashion for such as taking notes during the session and may also provide the scheduling information related to the lecture as well as any other pertinent information connected to the lecture. In one embodiment, components of the old software may be integrated into SW 114-116 and made to function through the new integrated interface. There are many possibilities for personalization of SW 114-116 to accommodate specific client needs.

In one embodiment of the present invention new function is added to enable a client to perform some educational tasks in an offline mode rather than being required to maintain a live connection to an ES server. Using an example of an online test, an ES server may require that when a client logs-in to take a test, he or she must remain online while populating the test Web form with the required test answers. In such a case it may be that the server also times the client and at “end time” the form automatically closes and records the clients submitted answers regardless of whether all of the answers to the test questions were provided. One obvious drawback is the requirement to remain online during testing.

Using the system of the present invention, a static Web form used to conduct a timed test at an ES server may be translated into a Web form that may be downloaded and populated offline by a client using the software interface of the present invention. The Web form may be downloaded with an automated timer that will record the time used when populating the form with answers. After download, the client may go offline and then later take the test while offline. When the timer indicates that time has expired during the offline test, the client may then re-connect to server 106 and upload the Web form containing the test answers. Server 106 may then submit the test answers into the Web form provided at the ES server on behalf of the client with previous client permissions and may submit only those answers that were recorded within the timed interval to be fair.

Many educational tasks formerly requiring persistent online connections for performing those tasks can be mitigated to offline mode such that they may be performed offline by clients enabled with the SW of present invention. Such functional enhancements may depend in part on cooperation level factors existing between server 106 and any ES servers in place. Motivation for cooperation in this regard may include cost-saving bandwidth reductions for universities or other entities hosting the ES servers. It is duly noted that some ES servers in some educational institutions may already provide download facilities such as file transfer protocol (FTP) services for enabling “learn at your own pace” course work for accredited classes. However, many still require significant online persistence to complete course work according to required schedules.

One with skill in the art of integrated software systems will appreciate that the methods and apparatus of the present invention can add flexibility for clients that take an array of courses available formerly only through disparate systems and that much work regarding scheduling and interaction can be reduced by providing access to the materials through a single interface. Likewise, the social integration aspect of the present invention, much of which will be described further below enables a student or a faculty member to integrate non-academic online social and business interaction activities and contacts so that they may all be managed from the single interface.

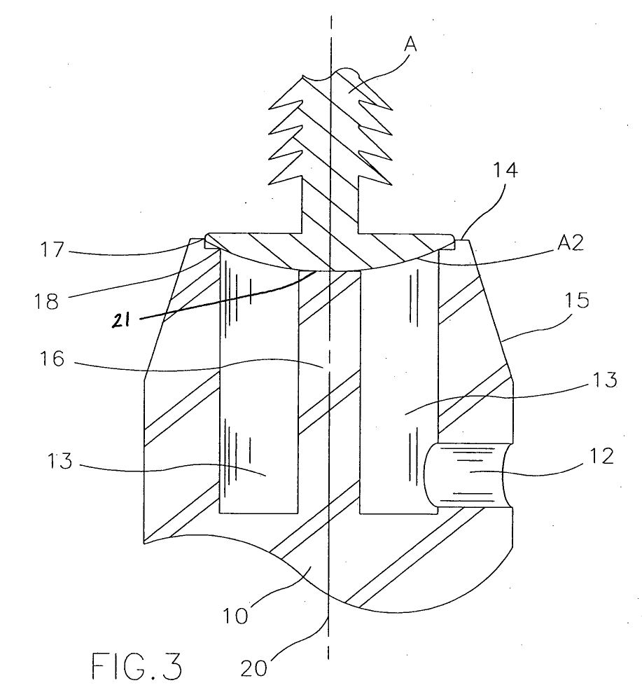

FIG. 3 is a screen shot 300 of a set-up interface representative of client application (114-116) for students according to an embodiment of the present invention. Screen shot 300 is analogous to the screen of FIG. 2 described with reference to U.S. provisional patent application 60/561,618 referenced herein and above in the cross-reference section of this specification. Screen 300 would appear after a client has downloaded the client software of the present invention from a main server such as server 106 described with reference to FIG. 2.

Screen shot 300 may be adapted, in one embodiment, to be displayed as hypertext markup (HTM) using any number of known web-browsing applications such as Internet Explorer™, Netscape Navigator™, Eudora Lite™, or others that are known in the art. In that case typical browser icons and dropdown menu options would be provided and illustrated herein. In this embodiment, set-up screen 300 is part of a suite that contains its own built-in browser application that may be used to browse the Internet, or alternatively may be used to call a resident browser.

Screen 300 has a title bar area 301 provided thereto and has a title displayed for identification reading “My Student Vision V. 1.0”, which is an exemplary title only. A title referenced in U.S. provisional patent application 60/561,618 FIG. 2 reads “Digital Pad for Student”. Title bar area 301 includes an array of dropdown menus 305 labeled File, Edit, Tools, Reports, Services, and Help similar to what may be provided in other graphical user interface (GUI) based HTM containers. Menus 305 may be expanded upon mouse click or key-board stroke to reveal multiple options for working with files; editing files; organizing or linking to favorite universal resource locators (URLs); tools for invoking functional modules and actions; tools for generating, viewing, sending, and printing reports; options for different web services available including addition of or configuration of or launch of, and option for using, and working with help files and resources both offline and online.

Title bar area also has a plurality of interactive icons 306 provided thereto and adapted to perform certain functions upon interaction therewith. Icons 306 range from commonly provided functions to unique and novel functions more relevant to the present invention. In this example, words are illustrated in place of actual icons for readability purposes. Reading from left to right, top to bottom icons 306 include the familiar Back, Forward, and Home icons, which control page navigation while browsing. A Schedule icon is provided and adapted to enable viewing, editing, printing, and sharing of a student's academic and social schedule.

A Classes icon is provided and adapted to enable viewing, adding, deleting, and modifying classes. An Assignments icon is provided and adapted to enable viewing, adding, deleting, and modifying assignments. A Take Notes icon is provided and adapted to enable a student to bring up a blank notes page for typing notes related to online or offline content. A unique aspect of this feature is that the note taking utility is a smart utility in that the format and naming conventions of files generated from the note taking facility are in some embodiments automatically assigned to names and formats relevant to the course work. For example, if course documents are typically generated using adobe acrobat for example then note pages are automatically saved as .pdf files named according to the most relevant course name, chapter name, or other name related to the assignment requirement. So if an assignment is to read chapter II in History then a notes page file may be names “History Notes 01 Chapter II.pdf.”

A Grade Book icon is provided and adapted to enable a student to view current grades and grade point average related to classes and assignments. A finances icon is provided and adapted to enable a student to view current bank balances, bills due, projection reports, tuition fees due and other financially related content. A reports icon is provided and adapted to enable a student to view system reports and to generate new reports related to educational and other activities.

A What ifs icon is provided and adapted to enable a student to run a variety of scenarios related to grades, finances, scheduling, and the like. For example, interaction with this icon launches one or more algorithmic-based program modules that may be manipulated to forecast certain results depending on data inputs. A Sync icon is provided and adapted to enable the student to synchronize offline content with online content stored in the student's personal space at the main server.

A My S-Vision icon is provided and adapted to enable a student to switch in navigation from any current HTM displayed to his or her personalized home page while online. A Search icon is provided and adapted to launch, upon interaction therewith one or more interactive Web and/or site-search interfaces. A Browser icon is provided and adapted to enable, upon interaction therewith, a standard browser interface adapted to enable Web navigation to URL locations. A More icon is provided and adapted to display more interactive options upon interaction therewith.

Icons 306 comprise a mix of standard and well-known interactive options and interactive options that are unique to the present invention. Icons 306 represent an integration of aggregated options that when considered together present an array of capabilities executable from a single interface that are not before known in any other aggregation of such capabilities in the art with respect to a single student Web-based interface.

Screen 300 includes a lower tool bar 303 that contains further interactive options, which are illustrated logically herein as words instead of actual icons for readability purposes. However one with skill in the art will recognize that many of the illustrated words are associated in the art with well-known icons. Reading from left to right in tool bar 303, a first icon Online is provided and is adapted to alert a student of online/offline status. In this example, the student is online. A next icon Updates is provided and adapted to enable a student to view and retrieve Web-based updates to software registered to the student including the present interface and may also include configured updates to other relevant programs including platform and security updates.

A Security icon is provided and adapted to enable a student to view online security settings related to virus protection, firewall status, and other security related programs and lists that may be configured for application to the student's Web-based activities.

An Email icon is provided and adapted to enable a student to launch any resident email application that is installed locally on the student's computing device or any configured Web-based email services such as instant access mail protocol (IMAP) services that the student is registered with. Likewise, an Instant Messaging (IM) icon is provided and adapted to enable a student to launch any instant messaging program. Familiar portal icons Yahoo™, AOL™, and Google™ are provided and adapted to enable a student to launch any of those portal-based services including related search services provided by Google™.

It is noted herein that invoking any of the icons illustrated within tool bar 303 does not necessarily cause a navigation sequence wherein the present screen is left or discarded for a new screen related to the service or services represented by the invoked icon. Rather, in a preferred embodiment, the listed service hosts may have applications and services configured to integrate with the current screen 300 in a fashion that enables a student to multitask with a variety of third-party offered services and still perform education-related tasks all from the same screen. In a preferred embodiment, this enhancement applies to all interface HTMs that are part of the suites user interface (UI) display architecture. Likewise, screen 300 and other like screens are not limited to HTM architecture. For example, WML pages may be provided for wireless applications, and various extensions of the HTML format including XML generated display capabilities may also apply.

Screen 300 has a side navigation bar 305 provided thereto in a fashion known with many online-capable UI windows. Navigation bar 305 may be configured to list navigable destinations presented as links arrayed in a typical platform file/folder format enabling collapse and expansion of the list. In this example, the destination Home (home page), Inbox (messaging), and Set Up (current view) are displayed.

Screen 300 has a workspace window 302 provided therein and occupied with an HTM page containing a variety of set up configuration options 304a-i. After first downloading the client application of the present invention (114-116), a student may spend time setting up and configuring functionalities, options, and presentation preferences for using the application. Workspace window 302 as well as any embedded or invoked screen may be scrollable using standard scroll-bar functionality provided and adapted where necessary for the purpose.

Reading alphabetically through provided configuration options 304a-I, a Profile option (304a) is provided and adapted to enable a student to input, view, and set up sharing of the student's desired profile data that may include name, occupation, chat handle, email address, contact information, likes, dislikes, and other descriptive data about the student that the student wishes to make available for others to view.

A Calendar option (3045b) is provided and adapted to enable a student to configure his or her personal calendar including adding events, setting viewing parameters, and setting share parameters to enable others to view the student's calendar.

A Classes option (304c) is provided and adapted for a student to manually enter class information and to view information already entered for the student via automation. An Assignments option (304d) is provided and adapted to enable a student to configure and setup new assignments and alerts. In some cases, class assignments are automatically entered when the student downloads the information from the service host if the assignments are available through the network. A student may configure offline assignments so that alerts may be configured related to due dates and the like and so that the assignment criteria may be viewed and incorporated into the student's classes view and schedule.

An Alerts/Reminders option (304e) is provided and adapted to enable a student to configure alerts related to assignment due dates, bill due dates, and other scheduled reminders. The student may also configure a list of devices that may be used to receive alerts generated by the system. The student may also be enabled to customize alerts to fashions, which please the student like preferred sounds, font sizes, graphic makeup, and other options.

An Academic Planning option (304f) is provided and adapted to allow a student to enter his or her higher learning goals and plans. Option 304f also has a GPA forecasting engine that can be invoked to help the student predict what grades in specific classes or courses will be required in order to stay inline with a desired overall or end-point GPA desired.

A Financial Planning option (304g) is provided and adapted to enable a student to setup and configure financial accounts and to setup account and loan balance sheets for view and analysis. The student may also enter preferences for reporting and viewing. A financial forecast engine (not illustrated) may also be provided in conjunction with option 304g for use in running different financial scenarios related to income, tuition, and financial obligatory factors.

A Time Saving Scenarios option (304h) is provided and adapted to enable a student to enter calendar search criteria and to have optional open dates returned and in some embodiments, suggested dates that may be used to schedule appointments that may be lumped together during one period on one day to save time and other resources. For example, if a student has more than one obligation that must be attended to that requires travel and both of those obligations may be satisfied at a same physical location then the system may suggest that those obligations be scheduled on a single day.

A My Student Vision option (304i) is provided and adapted to enable a student to set up his or her home page interface display properties and integration features. A student may apply synchronization rules, management criterion, and may add new functionalities and configure types and content of third-party offers that he or she wishes to be displayed on his or her home page.

It is noted herein that many configuration settings may be automatically provided by default such as when a student downloads class information from a professor that also uses a client application. For example, class details and data relevant to overall academic planning may automatically be entered into appropriate class, assignment, and planning interfaces without requiring any manual intervention. The same rule may be applied to several of the configuration options illustrated in this example under the general principal that if it can be incorporated by default without bothering the student with a configuration or data addition requirement than it will be.

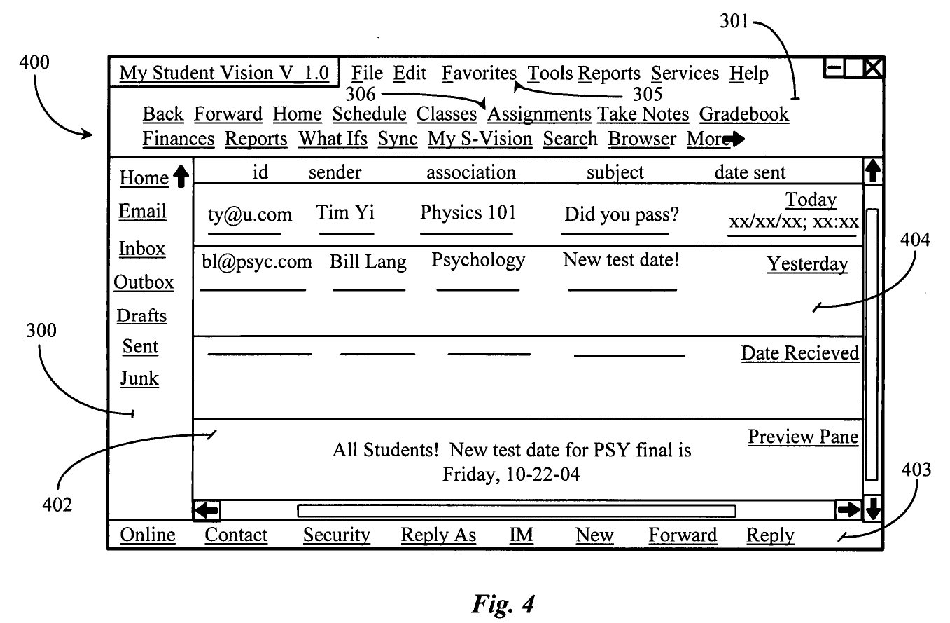

FIG. 4 is a screen shot 400 of a message inbox of a client application for students according to an embodiment of the present invention. Screen 400 includes the basic container architecture of screen 300 wherein navigation practiced causes only new content to be displayed within the application container. Therefore, features of the application container itself will retain the original element numbers and shall not be re-introduced in order to avoid redundancy in description unless new components are added and or integrated with those standard features.

In this example, a student has selected an icon Inbox from navigation bar 300 to cause display of listed messages. The icon Inbox represents a folder and may be associated in navigation sidebar 300 with other related folders like Outbox, Drafts, Sent, and Junk, typical of standard email applications. In one embodiment, a student may configure more than one email application to be launched from screen 400 without departing from the spirit and scope of the present invention. In another embodiment, one email application provided as a service by the entity hosting the client interface may be configured to enable interaction with messaging addressed to any of the student's email addresses. In this case one inbox could contain messages addressed to different ones of the students email identities.

A workspace 404 is provided within screen 400 and adapted to display the contents of the student's inbox. Likewise, invocation of any of the other folders from navigation sidebar 300 may bring up similar workspaces for displaying the content of those folders invoked.

Optionally, a preview pane feature 402 may be configured to display message content without requiring the message to be opened. In this example, messages are organized by date received and by sender id (from email address) sender name, the association of the sender to the student receiving the message, the subject of the message, and the date sent and/or received. There are many different ways to organize email messages for viewing as one with skill in the art will attest. Likewise there are numerous criterions available for categorizing and integrating email contacts. The present invention attempts to reduce workflow through integration and categorization of email messages through making an association of the sender to the receiver priority criteria, which may be configured by the student or may be automatically configured.

In a preferred embodiment, those messages from academic contacts like classmates, sorority contacts, professors, administrators, school service organizations, and the like may be given priority in queue and may be visible and configurable through specific association that is known. Moreover, with roster and other list information of other students, faculty, and academic facilities, a student's email inbox may automatically find and provide a summary association message for each email identity that is known to and registered with the system of the present invention. For example, a student may receive an email from ty@u.com, (Tim Yi) for the first time and may immediately realize that he is a fellow student taking a same class (Physics 101). In this case even though the student does not yet know who Tim Yi is, at least the student is comfortable that Tim is a trusted contact. In one embodiment, when a student downloads a class, all of the registered email identities and profiles of the other classmates are automatically added to a message white list by default.

In a preferred embodiment, if a student registers for online classes hosted by more than one disparate system even associated with different universities or colleges, for example, the central server application may integrate the email profiles of the aggregate of the attending classmates into the student's white list. Benefits of profiling classmates in the online educational world provide students with a sense that they are not isolated one-on-one with an automated grading system or a professor, but are included in camaraderie with the other students taking the class.

Screen 400 has a lower tool bar 403, which is analogous to tool bar 303 of FIG. 3 above except for the icon types provided. In this example, some icons illustrated in FIG. 3 are not illustrated here and new icons more relevant to messaging are introduced. These newer icons are message interaction centered such as Contact, Reply As, New, Forward, and Reply. In one embodiment, these message-related options are provided in a dropdown menu instead of taking space in a tool bar. There are many possibilities.

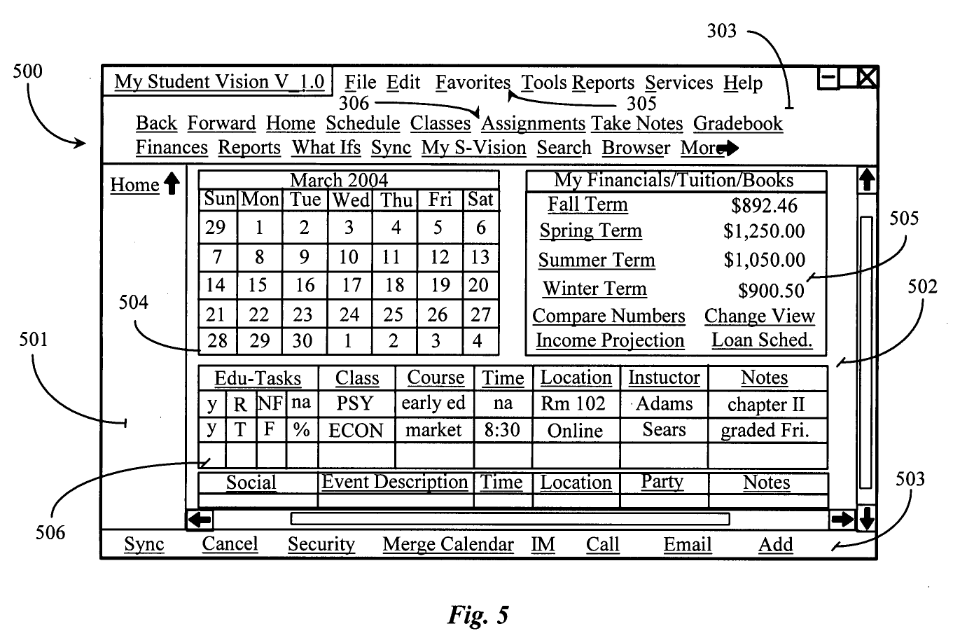

FIG. 5 is a screen shot 500 of an integrated home page of a client application for students according to an embodiment of the present invention. Screen 500 includes title bar 303, a navigation bar 501, which is analogous to navigation bar 305 of FIG. 3 and a lower tool bar 503, which is analogous to toolbar 303 of FIG. 3 except for a difference in content displayed.

Screen 500 has a workspace 502 that contains one or more integrated display windows adapted to display content according to user preference. In this example, workspace 502 contains a student calendar 504 that is adapted as an application for scheduling events and appointments, as well as reminding the student of those engagements. Calendar 504 is interactive allowing the student to click or mouse over calendar days to view event summaries and appointment summaries. Double clicking on any data enables schedule modification task input for adding, deleting, or changing appointments, start and end times, and so on. In one embodiment, appointment icons are available and appear over days in the calendar that contain events or appointments. In another embodiment, bolded or shaded days indicate dates involving appointments or scheduled events.

According to a preferred embodiment of the present invention, calendar 504 may be shared with other users and the owner of calendar 504 may view calendars of other users who have assented. A unique capability enables calendar merging of more than one calendar for the purpose of discovery of calendar dates and times that may be open for scheduling on the aggregate of calendars merged. The apparatus may be launched from a dropdown menu or toolbar 503 and involves a student selecting one or more calendars that other users have shared and merging those dates and times with his or her own calendar schedule.

Workspace 502 also contains a financial display window 505 adapted for displaying a student's financial information, in this case, tuition cost amounts for each academic term. An interactive option Compare Numbers is provided within window 505 and adapted to invoke, upon interaction therewith, a financial forecasting engine, which can be used, for example, to run financial projections against projected financial liabilities for a same period and return delta results. Another option labeled Income Projection is provided within window 505 and is adapted to enable calculation of projected income over a period using data input by the student.

An interactive option Change View is provided within window 505 and is adapted to enable a student to order other available financial views such as total loan balances accumulated or up to date job income figures. Still another interactive option within window 505 enables a student to view any loan schedules that they may have for student loans and the like. A student may customize window 505 and the types of views available. For example, a student may add a financial view that displays the total amount of monies owed to him or her by classmates or that he or she owes to classmates. Third party bank account information or other financial data a user has compiled with a third party may be imported to window 505 from another application or data source and may be integrated there within to be displayed as one of several available financial views.

Workspace 500 contains a display window 506 adapted to display the most current class schedule and social calendar data. These two categories of schedule information may be provided within the same window or they may be viewed in separate windows. In this case element number 506 refers to both a class schedule and a social calendar.

Class schedule information is organized in a table format using data rows and data columns. For class schedule information the data columns are Educational (Edu)-Tasks, which cover classroom assignments like homework. Under Edu-task there are four columns. Reading from left to right in table 506, a first column indicates whether or nor a task has an approaching due date. Table 506 may be configured to display only assignments due on that day, or it may be configured to display assignments or tasks that may come due within a certain time constraint attributed to display properties. For example, “show all assignments due by Friday” or view all assignments due today! Other views for educational tasks may be ordered by class type, course type, due date, and so on.

A second column under Edu-Tasks indicates what type of task, for example, R may indicate a reading assignment while T may indicate a test. A third column under Edu-Tasks may indicate state of the assignment in terms of completed or not completed. For example, NF may indicate not finished and F may indicate finished. A fourth column under Edu-Tasks may indicate importance of the assignment. For example, NA may indicate that the assignment is not graded or grading does not apply. A % icon may indicate that the task is worth a percentage of grade points. Each cell may be expanded to show further detail by mouse click. Moreover, full terms or words may be visible instead of space-saving acronyms.

A next major column title Class indicates the class title associated with each assignment. The first task due is a Psychology (PSY) class assignment and the second task due is an Economy (ECON) class assignment. The next title column over labeled Course, indicates the course work or class segment the assignment belongs to. For instance, the first task due is a reading assignment from the early education course material of Psychology class. The second task due is a test on the marketing segment of the Economy class.

A next title column indicates the time that the task should be completed. A next title column indicates the location for turning in the task or for completing the task. For the test, it is scheduled at 8:30 online. For the reading assignment there is no specific time and room 102 is the class location. So the reading should have been completed before entering that class. The next column lists the instructors whom assigned the tasks, and a final title column labeled Notes provides space for displaying and notes about the task that may be of importance to the student, including further details about the task to be completed.

A social calendar table 506 includes title columns Social, Event Description, Time, Location, Party, and Notes. Social events scheduled for that day would be listed in rows similar to the Edu-Task table. Workspace 500 may be scrollable as previously described, and may contain more display windows and data tables than are illustrated in this example without departing from the spirit and scope of the present invention. It is noted herein that a window adapted to display alerts and reminders for both social and academic obligations may also be included in workspace 502 as is illustrated with respect to FIG. 4 of U.S. provisional patent application 60/561,618.

Toolbar 503 contains interactive icons that are more relevant to the content displayed in workspace 502 such as added icons Call, IM, Email, Merge Calendar, and Cancel. Such options may alternatively be provided in a dropdown menu format or may be accessible through right clicking on an item requiring modification or attention.

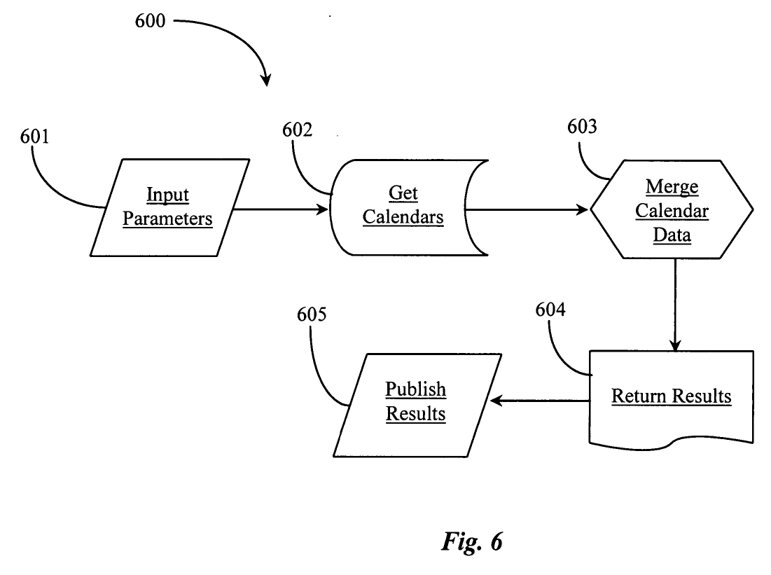

FIG. 6 is a process flow chart 600 illustrating steps for merging student calendars according to an embodiment of the present invention. At step 601, a student wishing to discover open dates among more than one calendar may input data parameters into a data input field of a calendar-merge function module that may be provided as part of a client application or part of a server-based application available to the client. Those parameters input by an operating client may include input dates and time parameters that may be preferred dates and times for holding a particular event or collaborative project among participants whose calendars will be compared. Input data may include identification of desired participants, nature and priority level of a proposed event or project requiring scheduling among the participants, and any repeat parameters or parameters specifying that the proposed event is a recurring event or should be scheduled over more than one day and time over the considered calendar period.

At step 602, the system gets the calendars or calendar data specified by the input user identities. It is noted herein that parameters input in step 601 may also specify a calendar period for run, which may be shorter than a typical calendar month or longer than a calendar month. Likewise, the run period selected may overlap calendar months. There also may be more than one calendar period run where two or more consecutive periods border calendar periods that may not be considered for run, for example, holiday break periods or the like.

After obtaining the calendar information in step 602 the data from all of the retrieved calendars are merged to expose one or more calendar periods containing the obligations of all of the participants. In this operation all commitments and shared open dates and times may be rendered as data results of the operation. At step 604, results may be returned to the requesting client interface for display. Results may be ordered according to a number of views and may reflect return and display criteria entered into the process at step 601.

At step 605 the results may be electively published to the participants whose calendars were considered in the process. In step 605 a “merged calendar view” may be pushed into the interfaces of participants when next online, or may be retrieved from email inboxes, or other message boxes. It will be apparent to one with skill in the art that the calendar merge or sync process may be performed online or offline. In either mode, a student may run more than one test scenario before publishing results by changing input parameters and then rerunning the test. Group assignments, Group social engagements, events, and the like are more easily planned leveraging this feature of the present invention.

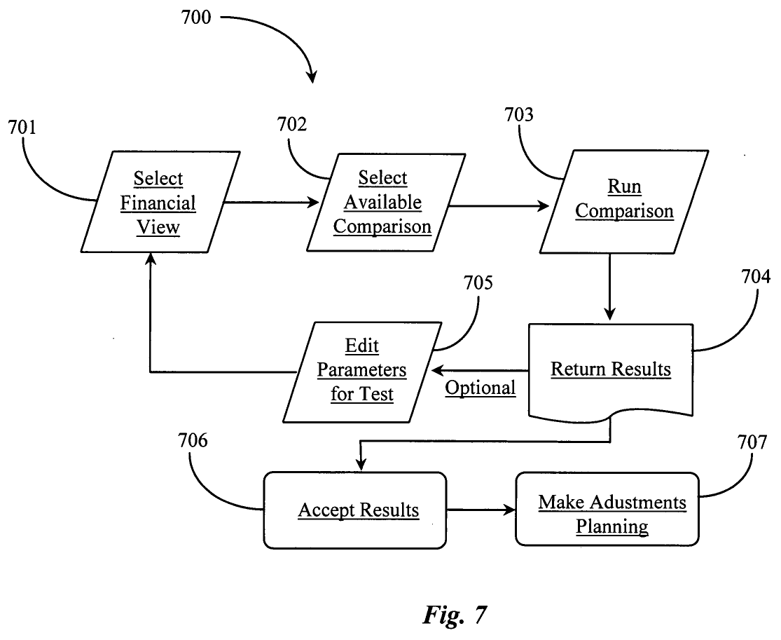

FIG. 7 is a process flow chart 700 illustrating steps for predicting financial scenarios according to an embodiment of the present invention. In one embodiment, a planning module, termed a financial forecasting engine, is provided for enabling a student to plan various financial scenarios and forecast needs and requirements for continuing academic goals. Such a forecasting module may be invoked from a dropdown menu or from an interactive option provided as part of a student's financial display window as described with respect to window 505 of FIG. 5 above. At step 701, a student selects a financial view that is already part of the student's configured data. One financial view or display can be compared against another complimentary financial view. An example might be to compared a projected income report against a financial needs report projected over a same period of time like a semester or one or more academic terms.

At step 702, an available comparison scenario is selected in order to invoke the proper algorithm for the type of comparison. For example, running a projected income statement against a projected financial needs statement may provide results that lead to important and time critical changes in the way a student manages his financial life. In one example, a simple comparison of financial income and financial requirements is performed. At step 703 the student runs the selected comparison. An algorithmic process crunches the numbers from both financial views and produces result values. In this case, values returned at step 704 would identify a surplus or a shortcoming of income compared to current financial requirements. Such a comparison may consider many financial variables such as multiple income sources and deposit schedules including loan balances, job income, parental contributions, and so on. Financial requirement views may also include an aggregate of financial variables like rent payments, tuition installments, loan installments, bills due and so on.

Scenarios may be created around actual input values or predicted values that may or may not be currently realized by the student. Therefore, at step 705, a student may optionally edit test parameters and re-run the scenario with new or modified parameters looping back to step 701.

At step 706, a student may accept test results as accurate enough to plan around. Such results may include total delta values, averages, differences, totals, percentages, and other typical financial value expressions. At step 707, a student may initiate adjustments in lifestyle or planning in order to realize requirements for successful academic financing. One with skill in the art of student profiling will realize that there are many factors that may contribute financially to that particular student's requirements.

Therefore, each student may have personal and customizable views based on real circumstance. For example, one student may have money coming in through a job, parental contributions, loan proceeds, and investment accounts. Another student may have money coming in through a job and a scholarship program. Likewise, a student's financial requirements may widely vary. For example, one student may have credit card debit, and tuition requirements, but may live on campus in a low-cost dormitory while another may live off campus in an apartment and therefore responsible for rent and utilities. Gasoline, car payments, cellular phone bills and the like are common cost variables for a student. Therefore, a student may create a number of separate financial views that reflect singular accounts, responsibilities and income sources. Those views may be extended over future periods by running a projection using the financial forecaster. A financial comparison may consider several separate views when running an analysis.

Step 707 may be partially automated through system suggestions that take into account all of the numbers and calendar information available. For example, a system may suggest that a second job be undertaken for a number of hours and period of time in order to obtain necessary funds to meet a specific financial requirement through a projected period. The system may also suggest that the student spends significant time each month in social engagements, which if eliminated during certain periods would provide the time necessary for the new job. However, if the student also requires more study time to improve GPA, the system may suggest some other strategy for raising the funds like applying for a student loan. In a robust embodiment, the forecasting engine may also rely on a substantial amount of data and rules provided by default in order to enable certain predictive, planning, and suggestion capability. Such data may also include available information about the local area or the municipality that the student lives and works in, current job market data, and current area resource information.

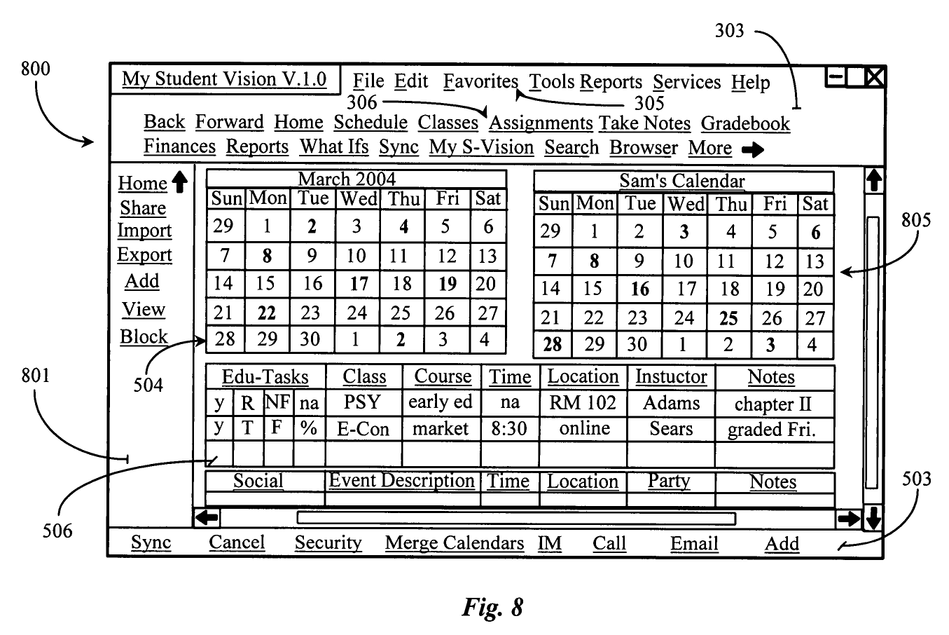

FIG. 8 is a screen shot 800 of an integrated home page illustrating a shared calendar view according to an embodiment of the present invention. Screen 800 represents an alternative home page view wherein a student has configured a second calendar view 805 to automatically display in the workspace area of the screen. Other home page view windows are analogous to those in screen shot 500 and may be replaced in some embodiments by views added in this example. A shared calendar, in this case, Sam's calendar is embedded as a view along side the student's calendar covering the same period. In this example, calendar view 805 replaces financial view 505 described with reference to FIG. 5 screen 500. In this example, the bolded dates on each calendar indicate dates where engagements are listed. The student can click on any of Sam's dates in calendar 805 in order to view more details of Sam's scheduled engagements that are visible by permission. Any student may elect to share part of his or her calendar instead of all of his or her calendar with granularity down to single engagements. Therefore Sam may have engagements related to calendar 805 that are not visible to the student operating screen 800.

Screen 800 has a navigation bar 801 analogous to previous navigation bars described except that the actual options displayed are more relevant to the configuration of screen 800. For example, a Share option is provided and adapted to enable the student to configure sharing of his or her calendar data. An option Import is provided and adapted to enable the student to select a calendar to import from calendars shared by other students. An option Export is provided and adapted to enable the student to export portions or his entire calendar to a central location or to other network locations.

An option Add is provided within navigation bar 801 and is adapted to enable a student to add calendar information. Such functionality may also be provided through interaction with a calendar view such as by double-clicking a calendar day. An option View is provided and adapted to enable the student to navigate to a desired calendar in his or her share list and to add it to interface 800 as a displayed calendar view. More than one shared calendar may be added to interface 800 as a displayed calendar view. Likewise, other view windows can be added as desired and new windows do not necessarily replace previous windows unless so desired. Scrolling bars enable screen 800 to contain as much data as is desired for display.

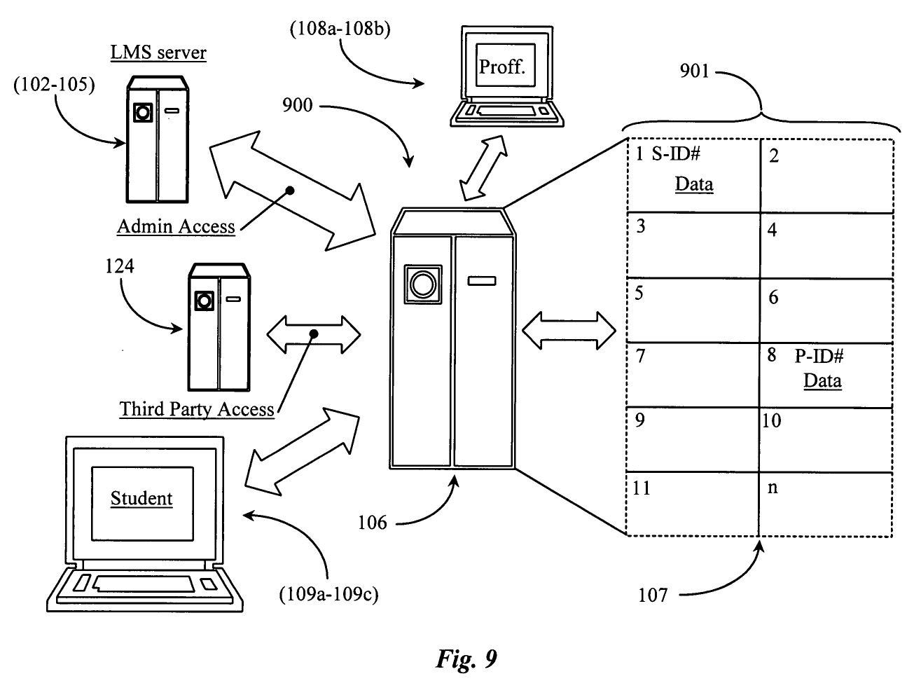

FIG. 9 is a block diagram illustrating an exemplary connection architecture 900 adapted for party interaction with the server of FIG. 1 according to an embodiment of the present invention. Server 106 includes memory or data space 107 containing individual memory blocks 901 (1-n) for all parties registered with server 106 that have a client instance of software configured for server access.

Students and professors may use their space for messaging, file sharing, storing online data, and for synchronizing that data with a like data store local to their computing devices used to access the server. Space 901 (1) belongs to a student registered with server 106 and has a unique server-assigned ID number (S-ID#). Space 901(8) belongs to a professor registered with server 106 and has a unique server-assigned ID number (P-ID#). Students (109a-109c) and professors (108a-108b) in this example may interact with each other's spaces to an extent allowed by file and folder sharing permissions set-up by individual space owners.

Spaces 901(1-n) contain all of the data for populating interface displays and messaging queues for delivering current email messages. Additional space may be provided within server 106 or connected to server 106, which may be adapted for hosting online chats and interactive meetings. Such space may be dynamically allocated as may be required.

Each student or professor registered with server 106 and operating a client instance of software may also forge connections to learning management system networks like LMS networks 102-105 for interaction with ES servers such as those illustrated in FIG. 1 of this specification. Such connections may be pure proxy connections forged with software generic to those servers or enhanced proxy connections forged with a client instance of SW. Third party servers like server 124 may connect to server 106 for the purpose of proving content to student and professor interfaces. Approved and/or ordered advertising content may be uploaded into spaces 901(1-n) for subsequent interface or home-page display the next time students and professors login to server 106. In one embodiment, third-party advertisements may also be inserted into meetings and online chats being conducted in real time.

In this embodiment, a student or professor may perform much work offline related to interface configuration, sharing configuration, setting preferences, preparing documents or lessons, and so on and may synchronize online thereby synchronizing with their personal spaces and affecting their online experience. Likewise, new information from students and professors including invites, system alerts, configured schedule alerts and reminders may be deposited in a personal space for integration and display at a next opportunity of connection and log in to server 106. FTP, messaging, and other network-based utilities may be adapted for use from personal space where allowed. For example, a professor may upload a test to an FTP site installed on that professor's personal space. The space may be made accessible through password or may be security-enhanced with white list method so appropriate students invited to interact have automatic access to the materials.

In this example, data in spaces 901(1-n) is formatted for use with client instances 114-116 described with reference to FIG. 1. Other server space may be allocated for storing forms and formats generic to LMS network data, which may undergo translation for use with server applications and functionality as previously described.

It will be apparent to one with skill in the art that providing access to personal space as described above enables personal data and interface display in a fashion that allows server access from any computing device operating a browser application. Therefore, a student away from his or her main computing device may still access information such as schedule, alerts, reminders, messages, and the like using a cell phone, a library computer, an Internet café computer, or even an Internet Kiosk without departing from the spirit and scope of the present invention. Server 106 may also provide a downloadable but limited version of the client SW of the present invention that may allow limited interactive function for students who are, perhaps borrowing a computer while on vacation for example, to complete assignments and other functions.

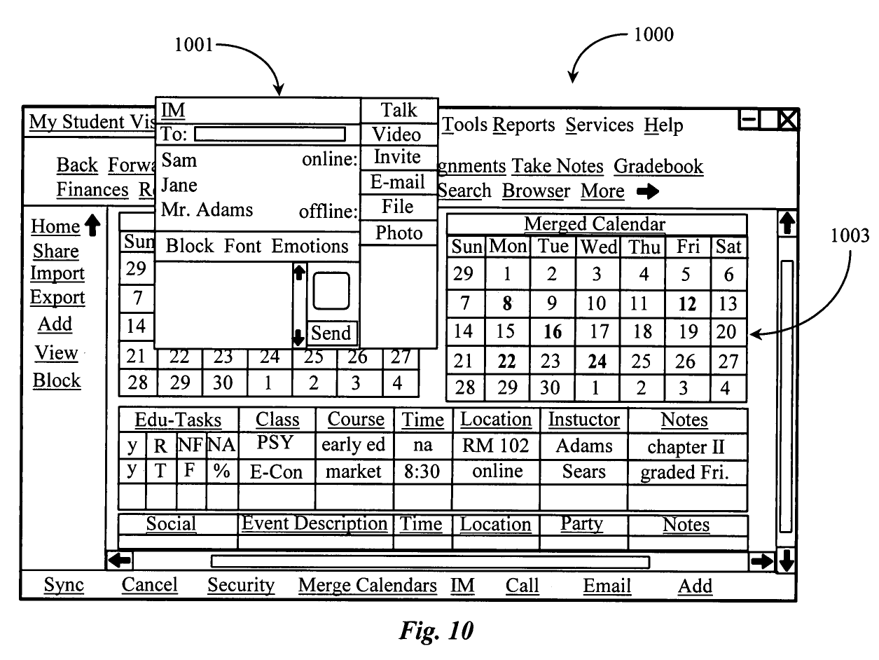

FIG. 10 is a screen shot 1000 of an integrated home page illustrating a merged calendar view and an IM interface according to an embodiment of the present invention. In this example, a merged calendar view 1003 is visible. Calendar view 1003 may be a view of the student's calendar and Sam's calendar described previously with respect to FIG. 8, calendar view 805. Calendar days illustrated in bold text may, in one embodiment, indicate open days wherein neither student has any engagements. A merged calendar view may be maintained on an ongoing basis between, for example, close school friends who often socialize with each other. Automated synchronization or updated merge data can be automatically populated into the merged view as it becomes available in each separate calendar. Therefore, the two students involved always have an updated view of available open days where a social engagement may be planned.

An instant massage application 1001 may be ordered at any time and embedded as part of the workspace of screen 1000 or as a floating window. IM 1001 may be used as is generally known for initiating communication with other registrants of server 106 in addition to other individuals listed in a student's messaging contact list. However, in this application, many IM contacts may be automatically added and removed by the system itself according to class roster information and the like. For example, if a student registers with a new online class, other registrants of the same class may be automatically added to the student's classmate contact list. Of course, a student may override system contact management functions to personalize his or her contact lists and may permanently block some contacts and add others from other online environments such as family and friends held outside of academic life. Rich contact categories and descriptions are provided for sorting contacts in preferred lists.

IM 1001, in a preferred embodiment, is enhanced with presence protocol to an extensible fashion for enabling schedule information from calendar entries and from real-time online engagements to be integrated with and therefore viewable from the interface. In this simple example, interface 1001 shows 3 contacts, Sam, Jane, and Mr. Adams. Sam and Jane are online. Sam may be the owner of merged calendar 1003 and by double clicking Sam's name within interface 1001, the student may view current presence information and calendar information integrated according to a timeline.

IM interface 1001, may be enhanced with voice messaging (Talk), and video messaging (Video). Invite functions, E-mail integration, File share integration, and Photo share integration is also illustrated in this example. More detail regarding unique IM presence reporting is provided immediately below.

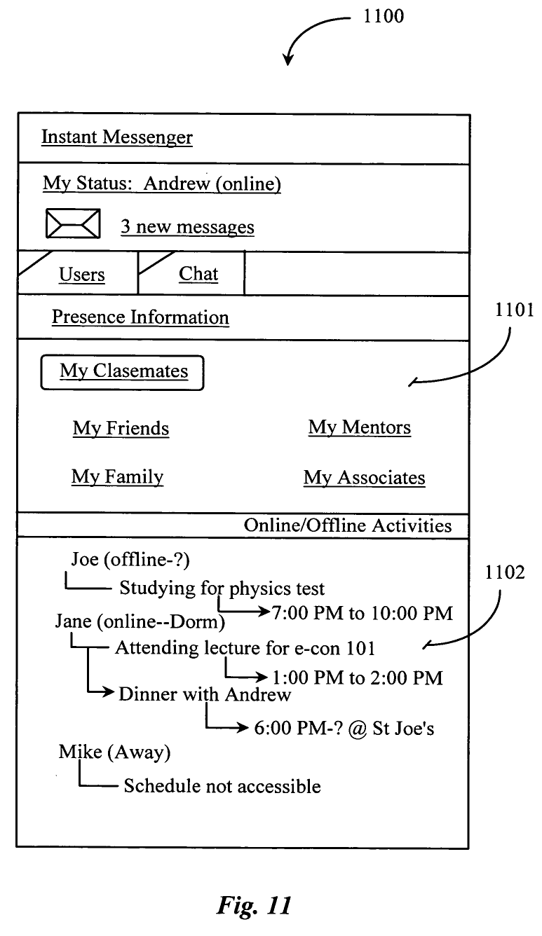

FIG. 11 is a screen shot of an IM interface 1100 illustrating presence location information viewable according to an embodiment of the present invention. IM application 1100 may be considered analogous to IM application 1001 described above with reference to FIG. 10. IM interface 1100 may be embedded to appear in a home page or may be configured to float in a separate window.

Interface 1100 illustrates the student's current status as online with 3 new messages. Tabs for viewing users and for viewing chat information are also illustrated. A sectioned window 1 101 is provided within interface 1100 and is adapted to list a student's, in this case Andrew's, contact lists including classmates, friends, mentors, family, and associates. Assuming that Andrew has selected My Classmates, he can see an unexpanded interactive list (not illustrated) of his listed contacts in this category. By clicking on any one of them, he can view presence information integrated with calendar information. This information may be viewable both in unexpanded and expanded version in a sectioned window 1102 provided and adapted for the purpose.

In this example, Joe, one of Andrew's classmates is offline at the moment in the dorm studying for a physics test from 7:00 PM to 10:00 PM. It may only be 1:00 PM when this calendar information is accessed, however the system knows that Joe, who shares his calendar with Andrew will be offline during the stated period for the stated purpose according to Joe's calendar.

Classmate Jane is online at 1:00 PM in her dorm and is attending a scheduled lecture for e-con 101 from 1:00 PM to 2:00 PM. This may be pure presence information enhanced with calendar information. For example, the system knows whenever Jane is online or offline and may also know that she is in her dorm if she is accessing e-con from a non-mobile or desktop computer. Her calendar information may supply the end-time of 2:00 PM.

If Jane permits the system to track her online class activity, it will know without calendar information that she is in e-con by the nature of the connection data revealing server address, accessing computer address and so on. Otherwise, calendar information may also be automatically accessed to show that Jane is participating in a lecture online at her e-con class. Further calendar information indicates that Jane has a dinner engagement with Andrew beginning at 6:00 PM at Saint Joe's Diner. If Andrew were to access Jane's presence information after 6:00 PM, he would see something like the following. Jane (offline)—attending a dinner engagement with Andrew at Saint Joe's Diner—End—?. Another classmate Mike is online but not accepting communication (Away) and his calendar schedule is not accessible to Andrew because he is not given permission to Andrew to view his calendar.

It will be apparent to one with skill in the art of presence protocols, that calendar data can be integrated with real-time presence information to provide a richer presence report for those individuals in a student's contact list who have consented to share the information with the student. The convenience of having this information available within the IM interface is apparent in that messaging contact, telephone contact may, in many cases, be immediately initiated relevant to persons listed.

Calendar information that is viewable through IM 1100 may be expanded out to the extent that a calendar is shared so a student may predict times that a friend or classmate may be online in the future and may schedule online interaction at those revealed times.

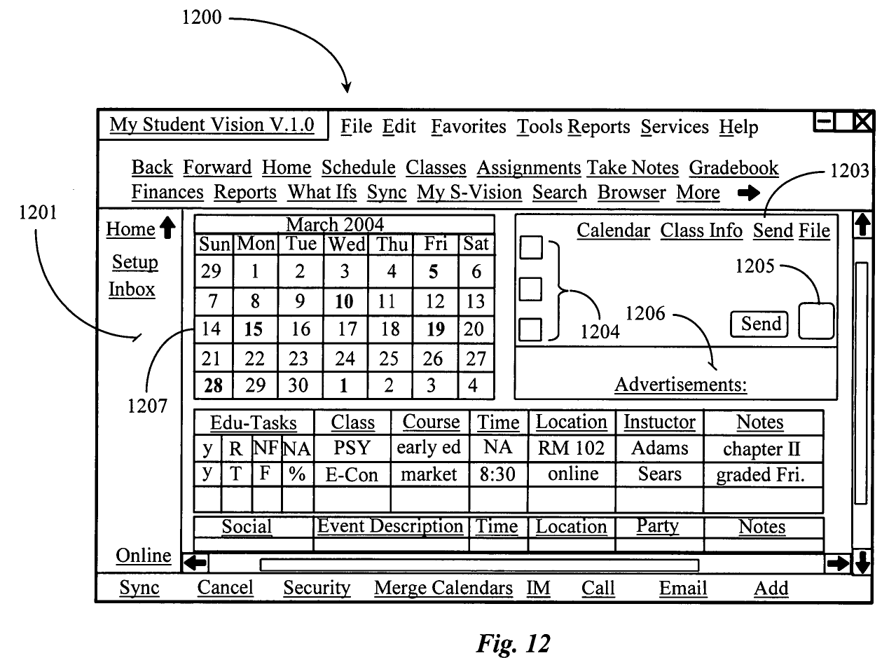

FIG. 12 is a screen shot 1200 of an integrated home page illustrating an embedded IM window and third-party advertisements according to an embodiment of the present invention. Screen shot 1200 included IM application 1203 as an embedded and integrated component of a student's home page. In this example, IM interface 1203 is configured with options Calendar, Class Info, Send, and File. Contacts of the student may, in one embodiment, be represented as picture thumbnails for quick identification such as contact thumbnails 1204.

A student may select one of thumbnails 1204 and initiate actions related to that represented contact by then clicking one of the listed options. For example, by clicking or highlighting one of thumbnails 1204, a student may then click Calendar to view that contacts shared calendar or a portion thereof that is shared. Likewise, a student may view that contacts class information if it is shared by clicking on Class Info. A student may highlight or click on one of thumbs 104 and click Send in order to initiate a file transfer session. The option File can be used to locate a file to send. A thumbnail 1205 is illustrated within a text window of IM 1203 and may be a thumbnail picture of a contact that the student is currently engaging with. Text messaging can be practiced as is generally known by typing in the message text and then selecting send.

An advertisement window 1206 is provided within IM interface 1203 and is adapted to receive and to display third-party advertisements from any approved third-party advertiser. Such advertisement messages may be ordered to rotate to show a number of ads for limited periods of time. There are many possibilities. Navigation bar 1201 is analogous to those previously described above.

IM interface 1203 may be configured to display various features and interface architectures. In one embodiment, IM feature interfaces may be adapted to rotate in display from view to view in the integration window with each view lasting a few or several seconds. In this way all of the IM features are available from the instant window, which can be sized in order not to take up much workspace area.

A calendar 1207 may be the student's calendar, a classmate's calendar, or a merged calendar depending on selected view. Calendar window 1207 may also be manipulated through interactive method such as by right clicking thereon to display various calendar options, some of which may be similar to related options provided within IM interface 1203 such as view calendar for example. In still another embodiment, IM interface 1203 may be enhanced with controls that enable manual toggling between different views as well as different configurations like text views verses thumbnail views or icon views. There are many possibilities.

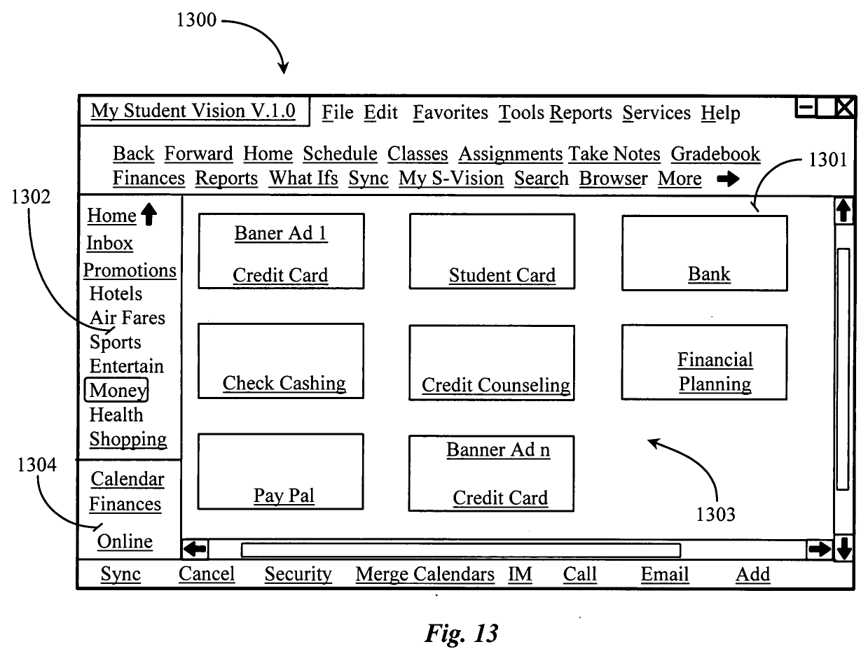

FIG. 13 is a screen shot 1300 of a promotions page populated with third-party offers according to an embodiment of the present invention. Screen shot 1300 may be invoked through interaction with a link or dropdown menu, or with some other link function provided on a home page or into one of various view windows. Screen 1300 has a navigation bar 1302 listing promotions 1303(1-n) maintained and updated for a requesting student. Under the title Promotions, which may be a file folder, there are listed options including Hotel, Air Fares, Sports, Entertainment, Money, Health, and Shopping. These listings in navigation bar 1302 represent interactive links to server-based content related to the listings and which are displayed, in one embodiment, as an HTM banner ads. Assuming that the file folder money is selected, then one or more pages or additional windows containing banner ads may popup. In this example, there are 3 credit card ads 1303, one being a student card. There is a check cashing advertisement; a Pay Pal™ advertisement; a credit counseling advertisement; a financial planning advertisement; and a bank advertisement. Navigation to other pages showing other promotions may be performed from the navigation bar 1302. It is noted herein that ads 1303 may be localized advertisements, or regional advertisements. There may also be a mix of local and regional advertisements.

A student may interact with any of the displayed ads to navigate while online to the ad hosts'servers. An additional section 1304 of navigation bar 1302 is reserved and adapted for calendar operations, financial operations, and online/offline status alerts. A student may elect not to have advertisements delivered into his or her interface. However, local advertising directed to students provides students with easy access to many services that otherwise may not be known to be available or might otherwise be hard to find.

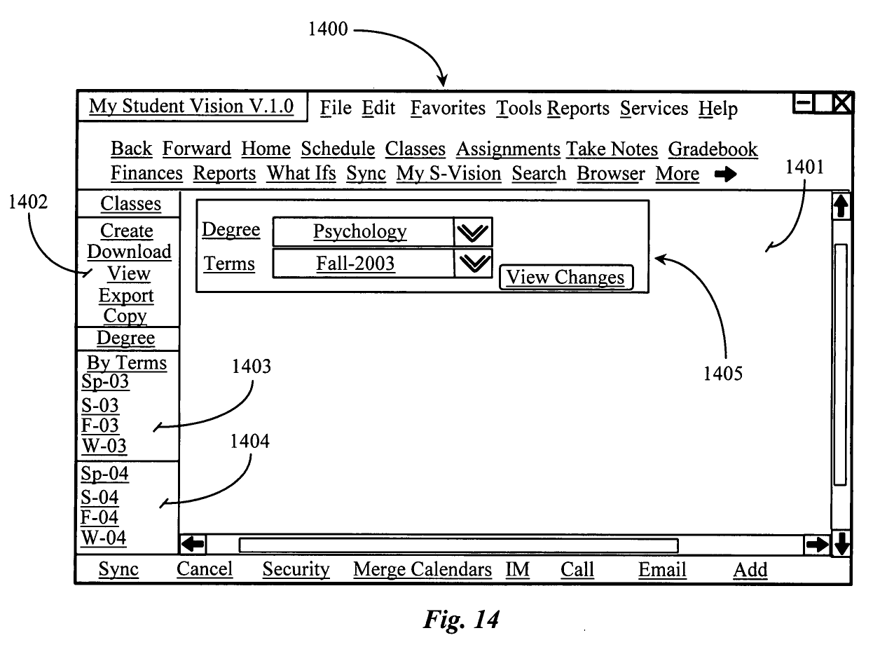

FIG. 14 is a screen shot 1400 of a student interface for adding class information according to an embodiment of the present invention. Screen 1400 is a class configuration interface that may be invoked from the option “Classes” provided in the options list in the resident title bar of the interface or from a dropdown menu adapted with the option. The class configuration interface enables a student to enter class information, delete class information or modify class information at any time. As previously described, where a registered class is an online class hosted in a server, all of the relevant class information may be automatically added to the student's class profile and downloaded into the student's interface. If the class is an offline class (not hosted on a server), the interface enables a student to enter all of the relevant data making the offline class a part of the student's online data, which may be shared and exported to other network locations. It is important to note herein that online class information may refer to any information entered into the system by a faculty member whether or not the actual class meets at a physical location or the class is entirely interacted with over a network. In some cases a class may entail a mix of both online activities and traditional classroom activities. Likewise, offline class information entered may include information relevant to course materials that are available over a network. Therefore, one with skill in the art will recognize that an online class in the broad sense depicts a class, which may be interacted with in whole or in part from a server interface whereas an offline class may be wholly conducted in a traditional classroom sense and whereas both may include relevant data that may be manually or automatically uploaded and integrated with a users online information and personal domain.

Screen 1400 has a navigation bar 1402, which contains a title folder Classes within which options are provided for interacting with the utility. Under Classes there is an option Create, which when invoked brings up a dialog screen wherein the student may begin entering class data. An option Download is provided and adapted to enable a student to download a class that has already been configured via automated registration online. An option View is provided and adapted to enable a student to view classes. An option Export is provided and adapted to enable a student to export class information to another application or interface. An option Copy is provided to enable a student to make a copy of class data.

A title folder labeled Degree is provided and enables a student to view all class and course information by terms over an extended period where data is available. For example a classes view may be ordered by term such as spring, 2003 (SP-03). In this ordered view, all class data relevant to classes registered for the spring term of 2003 become viewable and editable. Term folders are labeled and provided in navigation bar section 1403 for 2003 classes and in navigation bar section 1404 for 2004 classes.

Screen 1400 has a workspace area 1401 adapted to contain class configuration dialog tools or forms for entering and for viewing class data. In this example, a dialog box 1405 is displayed that enables the student to select a degree from a dropdown menu and a specific academic term a subsequent dropdown menu to bring up class data relevant to a class or classes applicable to the degree computer science wherein the class or classes are offered or available in the fall term. In one embodiment, dialog box 1405 enables a student to search for available online classes offered under the degree name for the specified term. In this embodiment, a student may also view and manipulate data that is already entered and organized under those headings. In this specific example a student is manually adding details for an offline class as will be detailed further below.

FIG. 15 is a screen shot 1500 illustrating further data entry fields invoked from screen 1400 for adding class details according to an embodiment of the present invention. Screen 1500 and screen 1400 are identical except for the displayed data entry fields visible in workspace 1401. By scrolling down in interface 1400 or by invoking a new window from screen 1400, further data entry stations 1501, 1502, and 1503 are accessible. Data station or block 1501 may take various forms and formats without departing from the spirit and scope of the present invention. In this example, it is of the form of a dialog entry box containing dropdown fields for a user to select.

For example, within dialog box 1501 a student entering class details may select the term of the class, in this case, Fall-03. Dropdown menus for selecting the start date and end date for the class are provided, for example 22, Aug. 2003 is the selected start date and the selected end date is 04, Jan. 2004.

A next data entry station 1502 is provided for adding class details and contains type-in data entry fields for entering class title, class ID number, class duration, and the number of class units credited for passing the class. In this example, the class is Psychology 102, the class ID number is Reader B-122a, and the duration of the class is a semester. The number of units for the class is 6.

A next data entry station 1503 is provided for the student to add the class scope information. Check boxes are provided to identify the available scope activities. In this case, check boxes for Lecture and for Teacher Assistant (TA) are checked but boxes for Lab and for Other are left blank thus defining the scope of the class.

A student may after populating stations 1501-1503 elect to create the class by invoking an icon labeled Create. This action adds the information to the students existing class information and may upload the data to the central server as well. Likewise, calendar data and other relevant data categories may be automatically updated across the domain.

An option for Cancel is also provided if the data is in error or the student wishes to abort the action. A reset option may also be provided to allow a student making changes to recover the old class description in the event mistakes were made.

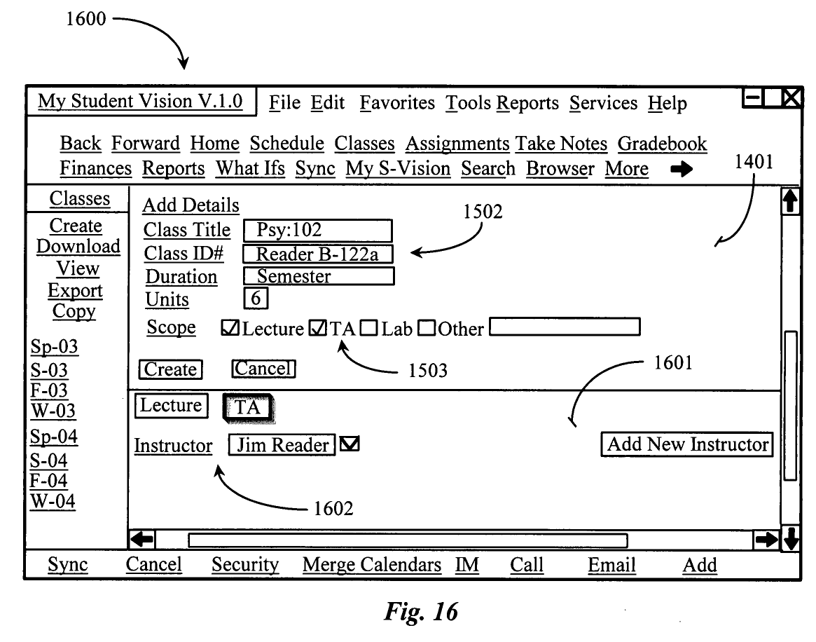

FIG. 16 is a screen shot 1600 illustrating further data entry fields invoked through screen 1500 for adding instructor details according to an embodiment of the present invention. Screen 1600 is achieved by scrolling further down in screen 1500 to reveal an additional workspace section 1601 containing a data option panel 1602 through which entry fields are accessible for adding instructor details, lecture details, and TA details.

Panel 1602 contains selectable icons representing existing class options for adding further detail. For example, icons Lecture and TA that were checked further above are now visible options here. A dropdown menu is provided to enable the student to select the correct instructor (if known to the system), or to, in some cases, add an instructor's name if the system does not know the instructor. In this case, the instructor for the class is Jim Reader. An option Add New Instructor is provided in case the system does have the instructor listed as a known instructor for the class. Invoking Add Instructor may bring up a data entry box whereby typing of the instructor's name therein automatically adds it to the list in the dropdown menu adapted to list known instructors.

Invoking Lecture, or TA enables a student to add further details about lecture dates, times and locations, and TA responsibilities and office hours. Such fields may be called up as data entry forms or boxes using a separate window. These options may also be provided in one embodiment by further scrolling down the workspace.

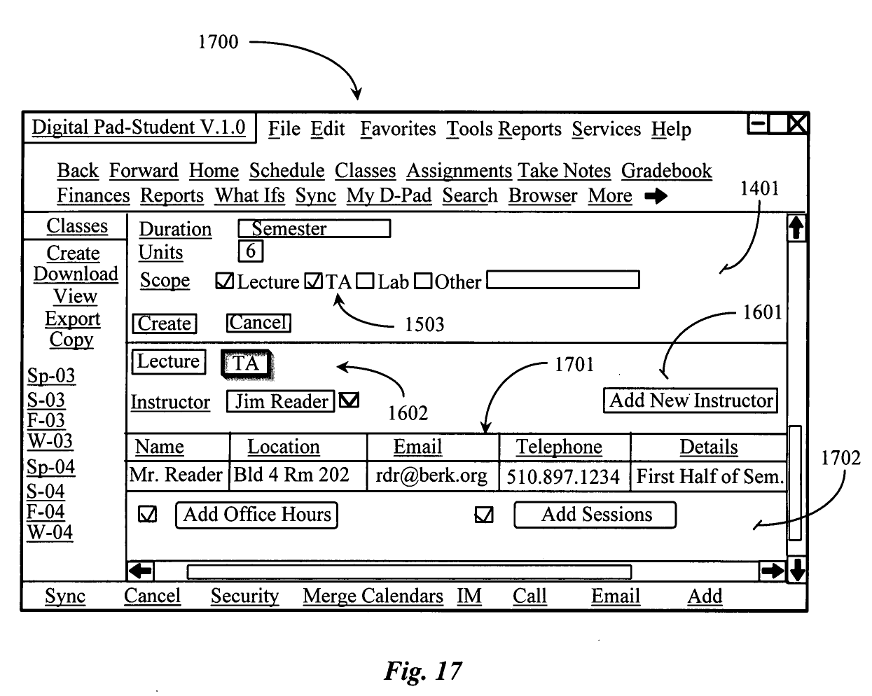

FIG. 17 is a screen 1700 shot illustrating further data entry fields for adding instructor details according to an embodiment of the present invention. Screen 1700 may be realized by further scrolling from screen 1600. In this example, a new workspace section 1702 is revealed that contains a table-entry box 1701 for adding instructor details. Table 1701 is broken up into 5 columns and one data row of blank cells in which a student may type in the relevant information. The information typed in concludes that the instructor in this case is Mr. Reader (Jim); the instructor location (same as class location) is building 4 room 202.

The instructor has an email address rd@berk.org, and a telephone number (510) 897-1234. A final column is headed Details and is associated with a cell for adding comments or further explanatory details. In this case it is noted that Mr. Reader will teach only the first half of the semester. In this case the student will add a new instructor at a later date, preferably before the beginning of the second half of the semester.

Options Add Office Hours and Add Sessions are provided beneath table 1701 and are associated with check boxes. If a student checks both boxes then he or she must further add lecture or session details and office hour details for facilitating TA activities or schedule. Directly invoking either option may also, in one embodiment, bring up separate interface windows containing the appropriate entry fields for adding the relevant information.

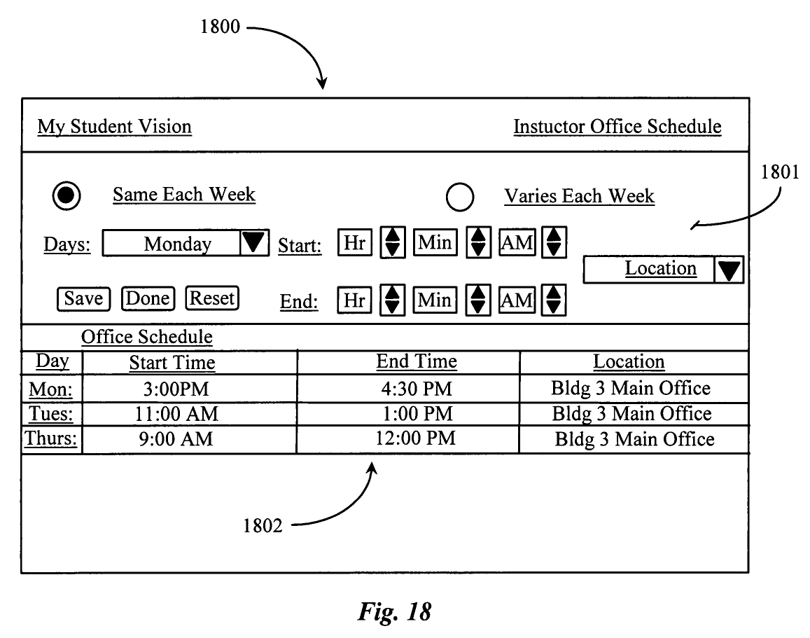

FIG. 18 is a screen shot 1800 of an office and/or session schedule input interface for adding office and schedule details according to an embodiment of the present invention. Screen 1800 may be invoked by selecting either or both options presented in screen 1700 for adding office hours and for adding session details.

Screen 1800 may be a separate window from screen 1700 or may be incorporated into screen 1700 directly. Screen 1800 is a popup screen in this example and may be assumed to be a floating window that may occupy space over the client interface. Screen 1800 has a workspace area 1801 that contains a configuration interface for quantifying and scheduling lecture sessions (assignments) that will be given by Mr. Reader during the term portion he is teaching the class. Options Same Each Week and Varies Each Week are provided to help a student configure the session details. In this case the sessions are at the same times and days each week.

A dropdown menu is provided and adapted for selecting a day of the week that a lecture will be given on. Associated dropdown menus are provided for configuring the time beginning and the time ending for each lecture session added. A dropdown menu is also provided for selecting a location where each lecture will be held. A student may operate the data entry station by first configuring the sessions for the first Monday of class and then save the settings from the array of options Save, Done, and Reset provided immediately below the dropdown for selecting days. The student then enters the timing and location information for that Monday session and clicks the option Save to add the information for Monday. Tuesday through Sunday lectures are similarly entered and saved until all of the lecture sessions for one week are entered. Because it is noted that the lectures are the same each week, the student may click the option Done to add the data to the class information, which also appears, as entered, in a table 1802. Now the first weeks lecture days and times are repeated for all of the weeks of the class.

For TA information the same interface is used in this case, data entry table 1802 may be adapted to enable a student to add TA office hours directly into the cells rather than to use dropdown menus illustrated in workspace 1801. Table 1802 is broken up into 4 columns associated with blank data cells into which a student types in the required data. For example, the TA responsibility is limited to Monday, Tuesday, and Thursday (Days column) for this student for this class. Wednesday and Friday are not TA days so they do not have to be included in the table. The “Same” or “Varies” options described above with regard to variance of schedule over a number of weeks may also apply to TA responsibilities.

In this case the TA schedule is the same each week. In the first column labeled Days. Monday, Tuesday and Thursday are entered. In the adjacent cells time-based data is entered under the appropriate columns Start Time and End Time. For Monday, TA is from 3:00 PM to 4:30 PM. The location for TA reporting is building 3 main office and is the same location for all TA activities for the class. However on Tuesday the start time is 11:00 AM and end time is 1:00 PM and on Thursday it is from 9:00 AM until 12:00 PM. The schedule repeats itself in this class every week that the teacher is actively teaching the class. Data table 1802 may populate itself through student interaction with dropdown menus in space 1801 and may be saved once populated to class details.

Screen 1800 may also be used to change existing class details when there is a change of information such as a new teacher coming in, or a change in TA or lecture dates or times, and so on. For online classes that are registered for wherein the professor has uploaded class configuration data for all students on the roster, manual data entry is not required. That is to say that details regarding online classes uploaded to the central server are automatically included in a student's class schedule by default. Likewise any changes or modifications to online class details initiated by a professor are automatically applied to a student's schedule. Automated alerts may be sent to student's whom have had automated schedule or class detail modifications and additions.

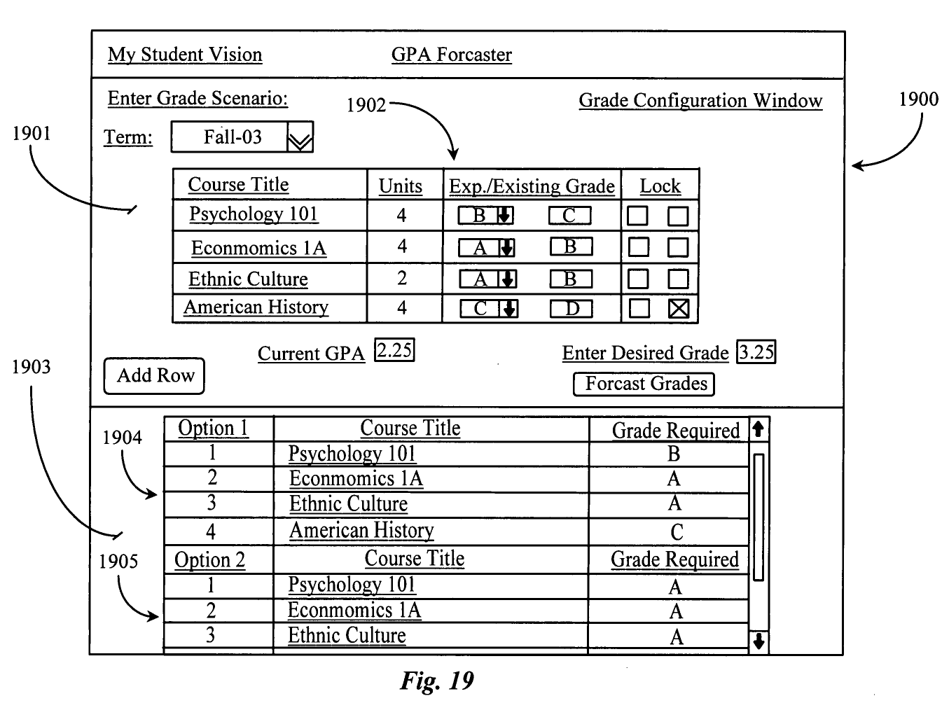

FIG. 19 is a screen shot 1900 of a grade point average forecasting interface for running GPA scenarios according to an embodiment of the present invention. Screen 1900 may be invoked through interaction with an option provided, for example, in the dropdown menu Tools illustrated in the persistent tile bar area of the main student vision interface of the client application described above. In this example, screen 1900 is illustrated as a separate window from the main interface, however it may be an embedded window and part of a home page configuration.

Screen 1900 has a grade configuration window or workspace 1901, which is adapted to accept input data and to display static data about individual class grades for a specific period of time. Workspace 1901 has a dropdown select menu adapted to enable a student to select a specific class term, in this case Fall-03. When a student selects a term option, the class data for that term is automatically retrieved for use. In one embodiment, instead of a dropdown select menu, a blank data entry field may be provided and adapted to accept a period of time expressed as a range in calendar format, for example from January 1 to August 5. In the later case, the system would retrieve persistent information related to active or scheduled course details known to be registered for the input time period.

Workspace 1901 has a data table 1902 provided therein which is adapted to display both persistent data and data that may input by a student. Table 1902 displays persistent course data retrieved by the system according to the time or period-based data input by the student. Table 1902 is broken up into 4 column headings and rows of cells adapted to display and to accept data input.

A first column heading Course Title compliments underlying cells displaying the active courses for the period Fall-03 selected. These are Psychology 101; Economics 1A; Ethnic Culture; and American History. Therefore, the student is actively attending the 4 mentioned courses during the term Fall-03. If another term were selected instead of Fall-03, then table 1902 would display course details relevant to different courses registered to the student and which are known to the system for the new period selected.

A second column heading labeled Units identifies the cells containing the units that are available for each course title listed in successive rows of table 1902. The class Ethnic Culture is worth only 2 units while the others listed are worth 4 units each.

Table 1902 has a third column heading labeled Expected/Existing Grade. This column identifies two types of data. Persistent grade data for each class is displayed. For example, for Psychology 101, the student currently has a C+. In the class Economics 1A, the student currently has a B−. In Ethnic Culture, the student's current grade is a B. In American History, the student is only managing a D+ in the class.

It is logically assumed that a student would run a GPA scenario for the term Fall-03, for example, sometime after the beginning of the term but before the end of the term in order to evaluate the level of study and effort that may be required to bring existing grades up to the levels that would attain a desired GPA. It is presumed in this example that current grade information is available for all of the classes currently registered for Fall-03. However, this is not required to practice the present invention. In one embodiment, some courses may not yet have a listed grade, in which case NA may be displayed as persistent grade indication for that course or the cell may be left blank.

Below table 1902 in workspace 1901, a cell is provided for displaying current GPA for the term according to the persistent grade values listed for each class. An add row option is also provided for enabling a student to add course information if for some reason it is not already part of his or her persistent course schedule. A cell is also provided within workspace 1901 and adapted to accept a desired GPA grade value for the selected period. In this case, one may recognize that the student's existing GPA of 2.25 falls well short of his or her desired GPA entered as value 3.2.

An interactive icon labeled Forecast Grades is provided within workspace 1901 and is adapted to enable the student to see one or more option scenarios that are displayed in a workspace area 1903 in table form. The options of which there are 2 displayed, table 1904 (Option 1) and table 1905 (Option 2) for the same course titles. The separate options reflect grade possibilities for the courses that when averaged together would produce the desired GPA entered in workspace 1901 as GPA value 3.25. For example, the system may be configured with various rules or constraint functions for forecasting new “expected grades” for the courses listed according to “least effort required” to raise persistent grades to the acceptable level.

In one embodiment, an algorithm may be provided that takes the existing or persistent grade values and attempts to raise those grades evenly across the number of courses until their average meets the desired GPA entered. It is possible that the grades may not be raised evenly if one or more persistent grades are particularly low. Therefore, the amount of leftover rise after the best persistent grades are maximized is attributed to the lowest persistent grade or is evenly distributed to the lowest persistent grades if more than one. In this scenario, the course or courses giving the student the most trouble is raised the least in expected grade, but the other courses must be aced. Similar rules may be provided and applied to one or more option scenarios.

In table 1904, a column labeled Grade Required defines the required grades for each listed course as figured according to algorithm and applied rule. In this particular example, the required grades are B, A, A, and C to attain a 3.25 grade point average according to a rule that evenly distributes grade rise across all courses. The first option results B, A, A, and C may automatically appear in table 1902 in dropdown cells as, initially the best expected grades under a rule that follows a “least effort” scenario for a student to raise his or her current grades across all four courses. A user may accept these results as the best possible results and may endeavor to work toward those goals for each course.

Alternatively, a student may have some knowledge, for example, a latest test score or some other indicator that a grade for a particular course cannot possibly be raised to the level forecast by the engine. In this case, a student may change the expected grade result returned after the first option is displayed and lock that grade in using a check box provided and adapted for the purpose in table 1902 under the Column Heading “Lock”. The student may then run the engine again with respect to the total number of courses having changed and then locked a forecast grade to one or more courses. This action may be repeated as many times as a student desires.

In this example, option one provides an evenly distributed grade rise of one level for each course title to obtain the desired result under a notion that effort to raise current grade levels is evenly distributed across all courses thereby requiring least effort in each course to obtain the desired result.

A student may lock a persistent grade to exempt that course grade from being changed by the forecast engine using a check box under the column labeled Lock in table 1902. It is noted that there are 2 separate columns of check boxes under the Lock heading. The left column associates with forecast grade results and the right column associates with the persistent or existing grades. In this embodiment, a student may have information that an existing grade is the best grade he or she can possibly receive in a particular course. The student may be willing to accept a lower grade in a particular course if the student cannot understand the material, is too far behind in the course and cannot drop the course from the term.

In the above scenario a student has locked the grade of D for the course American History but still wants to achieve a 3.25 GPA. The student reruns the engine and the results appear in table 1905 (Option 2) wherein the resulting expected grades for the unlocked courses are illustrated. In this case the student would have to obtain an A in each of the remaining course in order to maintain a 3.25 GPA with an accepted D in American History. If a student locks a persistent grade, then that same value may be reflected in the dropdown cell under expected grade for that course in table 1902.

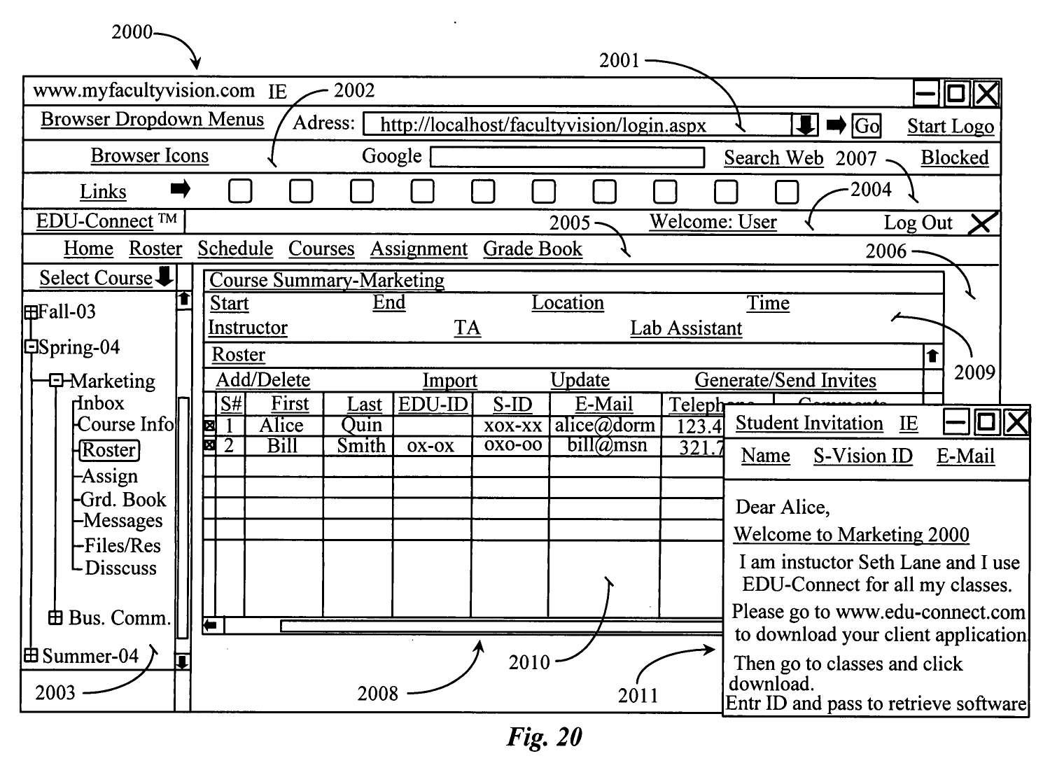

FIG. 20 is a screen shot 2000 of a client application for a faculty member illustrating a class roster according to an embodiment of the present invention. Screen 2000 represents a client interface similar to one adapted for a student except that it is adapted for a faculty member such as a professor. Screen 2000 may be analogous to SW 114, for example, described with reference to FIG. 1 and adapted for a professor.

In this example, screen 2000 is integrated with, or more particularly, contained within a browser application, perhaps provided as a browser plug-in. In another embodiment, the functionality may be Web-based entirely with the only download being a plug-in to enable interaction with the site.

As is typically provided with browser applications, there may be an address bar 2001 provided and adapted to enable a professor to navigate to a URL maintained in a Web server analogous to Web server 106 described with reference to FIG. 1. In this case the URL is a faculty-vision site personalized for the professor and the resulting screen 2000 may be a home page from within which the professor may execute workflow related to academic coursework, scheduling, lecturing, testing, grading, and other like functions performed by professors.

Screen 2000 has other typical browser-based implements like an array of standard browser icons 2002, and typical browser based dropdown menus. A Google™ search utility is illustrated along with another Search Web option along with a displayed array of icons 2007 representing links or URLs compiled as bookmarks or favorites all of which are typical in browser architectures.

A welcome bar 2004 is visible within screen 2000 and represents a personalized welcome feature for a connected professor. Bar 2004 has a log out option visible under the assumption that the professor is currently logged into the system. A title of Edu Connect™ is visible on bar 2004 indicating the host service name given to the overall system that may be practiced by students as well as faculty as previously described in numerous examples further above.

A menu bar 2005 is provided within screen 2000 and is adapted to contain and display interactive icons for navigating to various resources and functional interfaces. Icons presented for display on menu bar 2005 are illustrated as words in this example for readability purposes. For example, an icon Home is provided and enables the professor to navigate directly to his or her home page. An Icon Roster is provided and enables the professor to view and edit class rosters associated with courses that the professor is teaching on-line, and in some cases offline.

An icon Schedule is provided and enables the professor to schedule activities and edit or modify scheduled activities and engagements. In one embodiment of the present invention, the faculty vision client, as so termed by the inventor, has a calendar and calendar share capabilities like those described with reference to the student interface termed student vision, which has been the focus of discussion in this specification. It is noted herein that any functionality available to students through the student client application is also applicable to the professor version of the client application wherein those functionalities may lend usefulness to the professor's tasking and other activities.

An icon Courses is provided and enables the professor to view and edit course information and to add and delete course information. An icon Assignment is provided and enables a professor to create assignments, and assignment notifications. An icon Grade Book enables a professor to grade course work performed by students and to apply test grades, and other grade information to student's identified in a student roster.

Screen 2000 has a navigation bar 2003 adapted to enable file and folder system hierarchical indexing of locations and resources available to a professor. In this example, spring-04 is expanded to illustrate the professor's inbox. A next expanded option is Course information followed by Roster; Assignments; Grade Book; Messages; Files and Resources; and Discussions. Navigation bar 2003 illustrates the expanded options mentioned under the course marketing, which is part of Spring-04 course availability. Another section or class of marketing is illustrated as business community. A folder Fall-03 and Summer-04 are also illustrated and may be applied with the same expanded list of options available.

A workspace 2006 is provided with screen 2000 and is adapted to contain displayed results and functional dialog boxes and interfaces. A Roster 2008 is illustrated in this example as displayed in workspace 2006. Roster 2008 is that related to course marketing and contains all of the student data for students currently assigned to the course marketing under the specific professor.

When a student registers for available courses, the information is typically forwarded from administration to the assigned professors teaching the courses. Therefore, the professors know who is in a class before students do. In this case, roster 2008 is automatically populated with basic student data from the registration process. It is noted herein that this information may also be imported automatically by the system or manually by the professor into to the professor's personal server space (FIG. 9, 901b) from any one of ES servers 111a through 111d described with reference to FIG. 1 above. In the later case, the course marketing may an online course originally offered through one of the ES servers. The professor may also enter a complete offline course roster for the purpose of obtaining data organization capabilities through the system of the present invention.

Roster 2008 has a menu bar 2009 provided thereto and adapted to display interactive icons for performing certain tasks with respect to course workflow. A Start Icon is provided and adapted to enable the professor to enter a starting date for the course. An end icon is provided and adapted to enable the professor to enter an end date for the course. A Location icon is provided and adapted to enable the professor to enter a course location, for example a room (offline) or a server address (online). A Time icon is provided and adapted to enable the professor to enter class, lecture, and testing times and durations as well as class dates or other dates for those activities.

An Instructor icon is provided on menu bar 2009 and is adapted to enable the professor to enter profile information and details and contact information. A TA icon is provided and adapted to enable an instructor to identify TA students and to schedule times and dates for teacher assistant activities. A Lab Assistant icon is provided on menu bar 2009 and is adapted to enable the professor to identify student for lab assisting and to schedule those activities. It is noted herein that in one embodiment, each icon brings up a separate data entry dialog box for imputing the data relevant to the icon invoked. In another embodiment one or more icons may share a same Web form or dialog box within which data relevant to several or all of the icons may be entered at one time.

Roster 2008 has a table space 2010 for accepting student data about the students that are assigned to or have registered for the course. Each student listed as a registrant.

Data entered into one or more forms or dialog boxes is, in a preferred embodiment, is uploaded into the professor's personal space at the central server whereupon the system may analyze and automatically generate notifications to students who are already registered with the system of the present invention and have client applications and personal space allocated. In one embodiment, the professor notifies students after the course roster is made a part of the Edu-Connect™ server space. In this case, the notification may arrive through ES server connections or by other means and the students receiving the notifications are given instructions to navigate to the Edu-Connect™ server in order to download their client applications and their new course information that is if they are not already registered with the Edu-Connect™ system.

Students listed in a class roster such as in roster 2008 have a sequential row or list number. A first and last name is required for each student entry. An EDU-ID may be provided if the student already is registered with the Edu-Connect™ server. An EDU-ID is server assigned when a student logs into the central server to download software and class information. Therefore roster 2008 may not list an EDU-ID fore any students who are not already registered with the system. The student Alice Quinn row #1 has no EDU-ID because she has not yet registered with the system.

Each student listed in table space 2010 will have a student ID generic to the particular LMS or ES server that the course is available through. Students who are registered with the system of the present invention will have an EDU-ID and that ID will be associated with possibly more than one S-ID for different learning systems if the student is registered for classes in more than one educational system.

Each student is required to have an email address if the course is an online course and telephone contact information may also be part of roster 2008. A final column (not completely visible here) may contain comments from the professor. Only 2 students are listed in roster 2008 however one with skill in the art of online coursework will appreciate that there will typically be many more students listed.

Roster 2008 may be scrollable and can contain more columns for defining additional data tuples without departing from the spirit and scope of the present invention. Above table space 2010 there is an option for adding and deleting student rows. There may also be an option provided for importing information from other applications and from other network facilities subscribed to by the professor. For example, if a roster is being uploaded by a professor wherein the roster is yet incomplete, the professor my access the roster from the central server while online and import new entries from a similar roster that may exist in the learning system server through which the course is offered.

An option Update is provided as part of roster functionality and is adapted to enable a professor to update any part of an existing roster with new information. An invitation utility is provided as an option within roster 2008 and is adapted to invoke, upon interaction therewith, a messaging interface through which the professor may send a message to a student.

In one embodiment of the present invention, a student who does not have access to the services of the present invention, but instead is relying on their learning management system portal for interactivity, will not yet have a unique identification assigned to them because they have yet to login to the service of the present invention to register. However, the professor using the client application of the present invention (Faculty Vision™) may generate and may send an instant message to the student using the student using the enhanced IM application analogous to application 1100 described with reference to FIG. 11. In this case, the professor may manually add the students contact information into the IM application or alternatively, the information may be automatically added as a result of roster upload provided the IM ID of the student is included in the roster data for the student. The IM application of the present invention is compatible with other IM applications of prior art such as those currently offered through typical messaging service providers like AOL™ or MSN™.

If there are only a few students who require registration to the new system, the professor may elect to manually generate invite messages to those students. If however there are numerous students that need to register and download client applications, then the main server may automatically generate and send messages to those students based on a generic template provided by the professor. Merge functions may also be manually applied to send many messages from a single message invite frame. There are many possibilities. Likewise email messages may also be sent out.

It is noted herein that a student is not actually required to register with the system of the present invention in order to take the offered class through the ES server. Therefore, unique student ID allocation from the main EDU-Connect™ server does not typically occur until the students register with the system of the invention and download the client application. In the case of Alice Quin, she will not receive an EDU-Connect ID until she has downloaded the software.

A generated invite 2011 is illustrated in this example and represents an invite sent to Alice Quin to notify her of her class and the fact that it may be accessed in an enhanced manner using the EDU-Connect™ system.

The invite basically identifies Alice Quin as the recipient and welcomes her to the course she has registered for through the in-place learning system. The invite then introduces the course instructor and introduces the new system for interacting with the class. The instructor may recommend the new system in strong terms as instructors often do for class requirements, or the instructor may simply present the option to Alice who can decide whether to utilize the new system or not. In some cases, more information may be provided like a link to an interactive tour of the new system and client capabilities that are not offered with the in-place learning system.

Invariably, the message provides a URL and may provide a temporary or guest version of an S-Vision ID and password combination to Alice for enabling her to login and download her client software application and new class information from the site. Once Alice is registered with the new service and has downloaded her first class, future class downloads and notifications from other professors of other classes become automated.

It is important to note herein that in this example, the existing course is offered through an in-place learning system server. However both students and the professor of the course may interact according to course description, agenda, and schedule using the client application interfaces of the present invention through the server of the present invention instead of using the existing LMS Web-server interface. A server application may be provided to an existing ES server to enable a defined and formal Edu-Connect™ proxy interface to the server so that the server software, functionality and data can be abstracted for use by the system of the present invention. In some cases, no server modification is required if abstraction is merely an XML extension. That is not to say that complete new educational server environments are not possible using the system of the present invention as a replacement system entirely. However, it is recognized in the art that there are many older and established systems already in place such as those ES servers illustrated in FIG. 1 that can be leveraged through data modeling and migration techniques of the present invention.

The system of the present invention can be practiced with both professor and student onboard, only the student onboard, or only the professor onboard. Optimal functionality is realized when both students and professors are onboard with respect to leveraging an existing system. In this scenario, they have access to a much larger educational community.

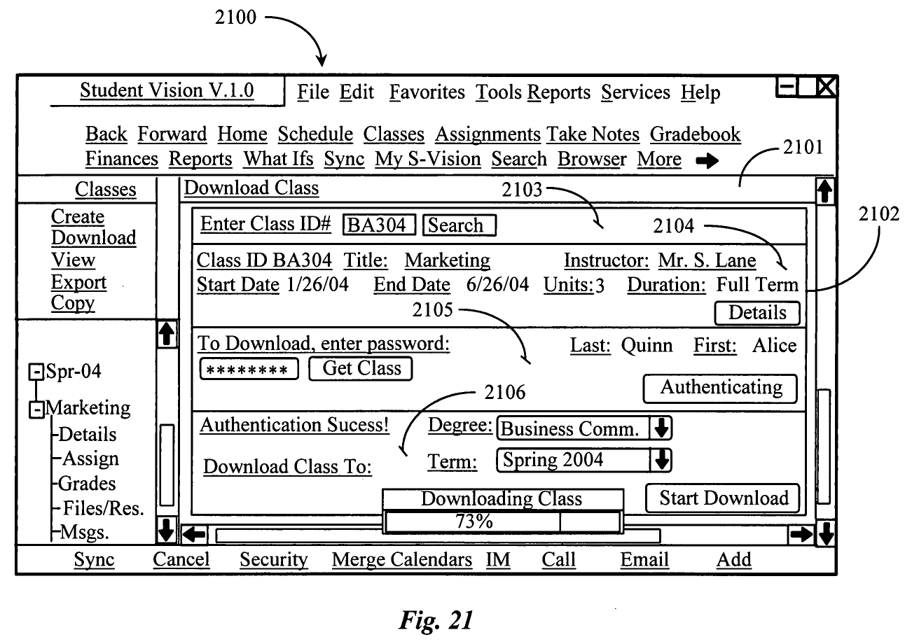

FIG. 21 is a screen shot 2100 of a client application for a student illustrating download of a new configured class according to an embodiment of the present invention. Screen shot 2100 represents a student interface used to download a new class after downloading and installing the client SW of the present invention. Screen 2100 is somewhat analogous to screen 1400 described with reference to FIG. 14 above except that screen 2100 is representative of a first information download initiated by a new student after downloading installing client software and after authenticating with the service by providing a guest ID and a password. It may be assumed that screen 2100 is a result of activity initiated by Alice Quinn after receiving an invite message with authentication information and instruction for navigating to the main server to get started with the service and retrieve a first class.

Screen 2100 has a progress bar indicating the activity “Download Class” that is in progress. An information download form 2102 is provided within screen 2100 and is adapted to display class information, to accept input data, to report authentication success or failure and to report current progress of the data downloaded from the main server.

Form 2102 has a section 2103 containing a data field for displaying or entering a class ID number, in this case BA304. An associated search icon for searching the server space for the class ID number is provided in some embodiments enabling the new client to enter the class ID information. In a case where Alice has received a message about the class as described in FIG. 21 above, the class ID # may already be displayed and the class data may already be located at the server end without requiring entry of class ID number.

A section 2104 of form 2102 contains the class details previously uploaded to the main server by the class instructor or professor Mr. S. Lane. A section 2105 of form 2102 contains an authentication routine adapted to authenticate the new student, in this case, Alice Quinn to download the class information and materials. To download the class a password must be entered that matches a password previously provided by the professor when his roster data was uploaded to the service. A status indicator Authenticating indicates forward progress in the activity.

In one embodiment, the password is simply the student ID assigned when the roster was created. In this case, an abstract server-assigned ID number is provided by the service to authenticate the new student for future interaction with the service. The single unique ID is then associated with any future student IDs assigned to the same student related to other courses made available through the service.

Form 2102 has a section 2106 for reporting authentication success or failure and for providing an icon to initiate the download of class information and any current materials to the new student's computing device. The service, in a preferred embodiment, also mirrors all student information and data to a personal server space allocated to the student so that when new information becomes available to that space, the student may synchronize with that space for the purpose of uploading and downloading data. In some embodiments the space allocated for the new student is a file transport protocol (FTP) server space. A download progress bar is provided to alert the new student of the current progress of the current download task.

Much information is already known about the new student as a result of the professor's activities. For example, the degree pursued by the student may be known in addition to initial contact information of the student provided by roster data. It is possible that the new student will add additional contact information that is not consistent with the contact information used to associate the new student with the professor's roster data. However, because a student must first register for a course provided through an in-place ES server, or through an administrative body if the course is an offline course, some piece of identification is always available with which to uniquely identify the student. As soon as the information is uploaded to the service, the abstract server-assigned ID is automatically associated with the other identification parameters.

In a preferred embodiment there is some formal level of cooperation between the main server (106) of the present invention and any leveraged ES server. A professor teaching an online course through an ES server may create his or her initial class roster using the existing ES software. In this case a server administrator may upload the information including any course materials to the service of the present invention over a dedicated link. Data abstraction and formatting enables the information to be re-packaged for use with the Student Vision™ application. Likewise, a student may still access the information via a pure proxy connection using pre-existing ES software or the server-based interface in a persistent online state.

The methods and apparatus of the present invention may be practiced in conjunction with any established educational system having an online presence without departing from the spirit and scope of the present invention. Students who interact with their online courses using the software interface of the present invention may manage all of their educational matters and other social and business matters all from a single interface even if access to classes, lectures, testing, and the like was formerly distributed over more than one connection and interface. Students practicing the present invention may enjoy new services that focus on an education community that is broader than a single university or learning source. The educational online community may include students from anywhere in the world where Internet access is available. Likewise, faculties using the service of the present invention are exposed to a broader class of professionals than would be available using their isolated and disparate regional educational systems. Online meetings, lectures, conferences, and the like could be provided as tools for professional education providers and consultants to interact with each other to gain new ideas and to share accomplishments and education methods.

Likewise, the methods and apparatus of the present invention enable offline and online environments to be merged in a way that provides instant access from a single interface to each environment. Online academic environments are rendered as simple to reach and interact with, as are the existing social online environments many students are already linked to through current Internet access conventions and portals. In addition, geographically sensitive resources are made instantly available to students to aid in planning and managing academic activities as well as day-to-day survival requirements.

The method and apparatus of the present invention may also in some embodiments be practiced completely in place of older in-place educational systems by first leveraging those systems for functionality and data and then eventually replacing those systems once all relevant data and functionalities are successfully migrated into the XML-based model and rendered useful in interaction with the client interfaces. There are many possible models and embodiments, many of which were already described.

It is also noted herein that the present invention may include some, but not all of the described components and functions, or, any combination of the described components and functions without departing from the spirit and scope. Therefore, the spirit and scope of the present invention should be afforded the broadest scope under examination. The present invention is limited only by the following claims.

1. A clip placement tool to nest and fixture plastic clip work pieces for automatic or manual insertion in a hole, the clip placement tool comprising:
a main body including a first feature disposed on a surface,
a second feature for attachment to a vacuum source, said vacuum source produces a vacuum in a chamber within the main body,
a nose portion opposite the first feature, said nose portion including a lip having first and second edges for receiving the work piece, whereas the lip is forward of the chamber,
a placement post positioned within the chamber,
wherein the placement post and lip provide support on a head of the work piece at all times during the insertion of the work piece in said hole.

2. The clip placement tool as recited in claim 1, wherein the main body is constructed of a lightweight material.

3. The clip placement tool as recited in claim 1, wherein the placement post is stationary.

4. A clip placement tool to fixture a clip for insertion in a hole, the clip placement tool comprising;
a main body including an attachment feature,
a vacuum source, said vacuum source produces a vacuum in a chamber within the main body,
a nose portion opposite the attachment feature, said nose portion including a lip having first and second edges for receiving a clip, whereas the nose lip is forward of the chamber,
a placement post positioned within the chamber, wherein the placement post and lip provides support on the clip at all times during the insertion of the clip in the hole.

5. The clip placement tool as recited in claim 4, where said attachment feature attaches the tool to a pick and place device.

6. The clip placement tool as recited in claim 4, where said first edge is a first circular seal surrounding said post and wherein said second edge is a second circular seal concentric with said first circular seal.

7. The clip placement tool as recited in claim 6, wherein said first and second edges include a face surface matching a surface on a head portion of said clip.

8. The clip placement tool as recited in claim 4, wherein said tool and clip share a common centerline when said clip is mounted on said post and wherein said tool is adapted to drive said clip in a direction along said centerline.

9. The clip placement tool as recited in claim 4, wherein said vacuum is adapted to hold said clip to said lip.

10. The clip placement tool as recited in claim 9, wherein a head portion of said clip forms a seal with said lip first and second edges.

11. A combination clip placement tool and clip for insertion in a hole, the combination comprising:
said tool having a main body including an attachment feature,
a vacuum source, said vacuum source produces a vacuum in a chamber within the main body,
a nose portion opposite the attachment feature, said nose portion including a lip having first and second edges for receiving a head portion of a clip, whereas the lip is forward of the chamber,
a placement post positioned within the chamber, wherein the placement post and lip engage the clip during insertion of the clip in the hole and wherein said tool maintains a vacuum on said head portion of said clip at least prior to insertion in said hole.

12. The combination as recited in claim 11, wherein said attachment feature is a machine screw.

13. The combination as recited in claim 11, wherein said lip is a circular seal wherein said first edge is an inner circular edge and wherein said second seal is an outer circular edge and wherein said lip includes a face surface that matches a surface on said head portion of said clip.

14. The combination as recited in claim 11, wherein said lip is a circular seal surrounding a portion of said chamber and wherein attachment of said head of said clip to said lip seals the chamber.

15. The combination as recited in claim 14, wherein said placement post is surrounded by said chamber and engages said head of said clip when said head of said clip is attached to said lip.

16. The combination as recited in claim 15, wherein said placement post is at a center of said circular seal.
